(19) United States
(12) Patent Application Publication
(10) Pub. No.: US 2021/0067972 A1
(43) Pub. Date: Mar. 4, 2021

(54) Detecting and Responding to Unauthorized Emergency Messages and Presidential Alerts

(71) Applicant: QUALCOMM Incorporated, San Diego, CA (US)

(72) Inventors: Charles MCGRATH, Bonita, CA (US); Subrato Kumar De, San Diego, CA (US); Ankur Bhattacharjee, San Diego, CA (US); Krishna Ram Budhathoki, San Diego, CA (US); Mattias Kaulard Huber, Solana Beach, CA (US); Brandon Luu, San Diego, CA (US); Sai Eshwar Prasad Muppalla, San Diego, CA (US)

(21) Appl. No.: 16/737,230

(22) Filed: Jan. 8, 2020

Related U.S. Application Data
(60) Provisional application No. 62/894,309, filed on Aug. 30, 2019.

(51) Int. Cl. H04W 12/12; H04W 4/90; H04W 4/06; H04W 12/06; H04W 4/12

(52) U.S. Cl. CPC H04W 12/1204; H04W 4/90; H04W 4/12; H04W 12/06; H04W 4/06

(57) ABSTRACT

Methods for detecting and responding to unauthorized alert messages. In an example embodiment, a wireless device may detect a first system information block (SIB1) broadcast from a base station that includes an alert message flag that indicates that an emergency alert message is scheduled for broadcast in another system information block (e.g., in one of SIBs 10-14, etc.). The wireless device may detect an unauthorized alert based on inconsistent inputs from various base stations, and the server may detect fake or unauthorized base stations or detect unauthorized alerts based on inconsistent inputs from various UEs about same Cell ID, or same PLMN and geolocation, etc.

### RELATED APPLICATIONS

This application claims the benefit of priority to U.S. Provisional Application No. 62/894,309 entitled “Detecting and Responding to Fake Emergency Messages and Presidential Alerts” filed Aug. 30, 2019, the entire contents of which are incorporated herein by reference for all purposes.

### BACKGROUND

Long Term Evolution (LTE), 5G new radio (NR), and other modern communication networks utilize many broadcast signals to transmit essential information from a cellular communication network to wireless devices. The broadcast signals may include synchronization information and radio resource configurations required for a wireless device to access the cellular network. The wireless device may receive and use these broadcast signals to register with the network through an Authentication and Key Agreement (AKA) procedure. After registration, the wireless device continues to monitor for the broadcast signals. For example, when the wireless device does not have a connection with a base station (e.g., due to its inactivity), the wireless device listens for paging messages broadcast on a shared channel. Even when the wireless device does have an active connection, the wireless device continues to listen for broadcast signals to determine potential changes in system-wide radio configurations and/or to identify the arrival of messages directed toward multiple wireless device.

Although most signaling messages are protected from modification using cryptographic primitives, the broadcast signals used to transmit essential information are not secured. For example, in LTE, communications between a wireless device and network are only secured after successful authentication and security handshake procedures, namely Non-Access Stratum (NAS) and Access Stratum (AS) security mode procedures for the protection of unicast messages. These unprotected broadcast signals may subject the system and wireless device to various vulnerabilities that can be exploited by a malicious or nefarious actor to launch cyberattacks, such as a signal injection attack, a signal overshadowing attack or a replay attack.

A signal overshadowing attack injects a manipulated broadcast signal into a wireless device by employing a fake or unauthorized base station. This is possible because the LTE base stations transmit essential information, including SIB messages, periodically (with a fixed time gap) in unprotected broadcast signals. An attacker may collect the essential information transmissions from nearby base stations to determine the synchronization and radio resource configurations to transmit in order to appear to be a legitimate base station. The attacker may transmit an attack signal (e.g., a manipulated broadcast signal, etc.) that wireless devices receive as stronger than the signals from a legitimate base station, typically due to a much closer proximity of the attacking base station to the wireless device. The attacker may also synchronize the timing of emulated or copied essential information transmissions to coincide with the broadcast transmissions of the targeted legitimate base station. Because the wireless device frequently listens for broadcast signals, and due to a phenomenon known as the “capture effect” in which wireless devices that concurrently receive multiple overlapping signals only decode the strongest signal, the wireless device may receive and decode the stronger attack signals of the fake or unauthorized base station. A fake or unauthorized base station could then include false or non-benign transmissions that causes the wireless device to display unauthorized presidential alerts and unauthorized emergency messages (e.g., fake, replay or out-of-area ETWS or CMAS messages) to launch a denial of service (DOS) attack, invoke mass public reactions (e.g., widespread panic, etc.), undermine long term public trust in CMAS/ETWS messages, drain the battery and processing resources of the wireless device, or otherwise disrupt or hinder the services provided by communication networks and service providers.

In addition to the signal overshadowing attack discussed above, a malicious or nefarious actor may use software defined radio (SDR) boards, such as a universal software radio peripheral with open source LTE/3G/2G stacks to set up a fake or unauthorized base station that spoofs an actual base station of a network service provider and cause the wireless device to receive unauthorized presidential alerts or unauthorized emergency messages (e.g., fake, replay or out-of-area ETWS or CMAS messages). Further, a malicious or nefarious actor with inside access to a service provider network (e.g., a rogue employee of the carrier/operator network, etc.) may modify the network's subsystems to send unauthorized presidential alerts or unauthorized emergency messages to wireless devices that subscribe to that service provider network. By sending unauthorized presidential alerts and unauthorized emergency messages, the malicious or nefarious actor may launch a denial of service (DOS) attack, invoke mass public reactions (e.g., widespread panic, etc.), undermine public trust in CMAS/ETWS alerts, drain the battery and processing resources of resource constrained computing devices (e.g., smartphones, etc.), or otherwise disrupt or hinder the services provided by communication networks and service providers.

Additionally, real alerts can be received by devices, such as software defined radios, then decoded and saved. Real alerts may be only intended for a limited location and/or time frame. A malicious actor can record and replay these alerts via a software defined radio at locations and/or times for which the alerts were not intended. Even if valid messages broadcast in the future are signed, a malicious or nefarious actor may still replay them when and/or where they are not intended (i.e., where/when the alerts are invalid), but wireless devices will decode them as valid. Even if valid messages are timestamped, the messages can be replayed during the valid time-frame but at a different location where the messages are invalid.

### SUMMARY

The various aspects of the disclosure include methods of detecting and responding to unauthorized presidential alerts and unauthorized emergency messages that may be performed by a processor in a wireless device. Various aspects may include detecting a broadcast from a base station of a first system information block (SIB1) that includes an alert message flag (e.g., a value, bit, bit field, Boolean, etc.) that indicates that an emergency alert message is scheduled for broadcast in another system information block, receiving the emergency alert message from the base station in response to the SIB1 including an alert message flag that indicates that an emergency alert message is scheduled for broadcast, activating receiver circuitry to scan for SIB1 broadcasts from current neighbor base stations that are at least within receive-only communication range of the base station of the wireless device in response to the SIB1 including an alert message flag that indicates that an emergency alert message is scheduled for broadcast, receiving an SIB1 broadcast by a current neighbor base station, determining whether the SIB1 broadcast by the current neighbor base station includes the alert message flag, and determining whether the emergency alert message received from the base station is an unauthorized alert message based on whether the SIB1 broadcast by the current neighbor base station includes the alert message flag that indicates that an emergency alert message is scheduled for broadcast.

In some aspects, determining whether the emergency alert message received from the base station is an unauthorized alert message may include determining a valid alert count value, a valid alert probability value and an unauthorized alert probability value, determining whether the valid alert count value is equal to zero, determining whether the unauthorized alert probability value exceeds the valid alert probability value, and determining that the emergency alert message received from the base station is an unauthorized alert message in response to determining that the valid alert count value is equal to zero and that the unauthorized alert probability value exceeds the valid alert probability value.

Some aspects may include increasing an unauthorized alert probability value in response to determining that the alert message flag in the SIB1 broadcast by the current neighbor base station does not indicate that an emergency alert message is scheduled for broadcast or increasing an unauthorized alert probability value in response to determining that the alert message flag in the SIB1 broadcast by the current neighbor base station does not indicate that an emergency alert message is scheduled for broadcast. Some aspects may further include increasing a valid alert probability value and activating receiver circuitry to receive the scheduled emergency alert message from the current neighbor base station in response to determining that the alert message flag in the SIB1 broadcast by the current neighbor base station indicates that an emergency alert message is scheduled for broadcast, and comparing the emergency alert message received from the current neighbor base station to the emergency alert message received from the base station, in which determining whether the emergency alert message received from the base station is an unauthorized alert message may include determining whether the emergency alert message received from the base station is an unauthorized alert message based on a result of comparing the emergency alert message received from the current neighbor base station to the emergency alert message received from the base station.

In some aspects, determining whether the emergency alert message received from the base station is an unauthorized alert message based on the result of comparing the emergency alert message received from the current neighbor base station to the emergency alert message received from the base station may include increasing an unauthorized alert probability value in response to determining that the emergency alert message sent from the current neighbor base station is not substantially the same as the emergency alert message received from the base station. In some aspects, determining whether the emergency alert message received from the base station is an unauthorized alert message may include increasing the valid alert probability value and incrementing a valid alert count value in response to determining, based on the comparison, that the emergency alert message sent from the current neighbor base station is substantially the same as the emergency alert message received from the base station.

Some aspects may further include collecting information from multiple (e.g., some or all) base stations that communicate with the wireless device, categorizing the base stations into groups based on the collected information, generating a list of neighboring base stations that includes that communicate with the wireless device and the groups into which they are categorized, and generating a list (e.g., “Neighbor Priority list for Additional Scanning,” etc.) that identifies all of the current neighbor base stations that are within communication range of the wireless device and included in the list of neighboring base stations, and prioritizing the generated list based on the groups into which the current neighbor base stations are categorized to generate a prioritized list. In some aspects, activating the receiver circuitry to scan for SIB1 broadcasts from the current neighbor base stations that are within communication range of the wireless device may include traversing the prioritized list to select an unscanned base station having a highest priority, scanning for SIB1 broadcasts from the selected base station, and labeling the base station as scanned.

In some aspects, activating the receiver circuitry to scan for SIB1 broadcasts from the current neighbor base stations that are within communication range of the wireless device may include continuing to sequentially traverse the prioritized list to select other unscanned base stations based on their priorities or positions within the prioritized list until all unscanned base stations in the prioritized list are scanned or until a predefined number of base stations are scanned, and scanning for SIB1 broadcasts from each of the selected base stations. Some aspects may further include sending information collected or determined in the wireless device to a server computing device, and receiving a threat detection result from the server computing device, in which determining whether the emergency alert message received from the base station is an unauthorized alert message may include determining whether the emergency alert message received from the base station is an unauthorized alert message based on the received threat detection result.

In some aspects, sending the information collected or determined in the wireless device to the server computing device may include sending at least one or more of information indicating whether the emergency alert message was received in the wireless device, information identifying a type of the emergency alert message, a classification of the emergency alert message (as an unauthorized or valid message), a date/time stamped version of cells used to determine if unauthorized or valid with SIB1's SIB12 scheduling value, a valid alert value, an unauthorized alert value, content of the emergency alert message, a message number associated with the emergency alert message, a geographic region in which the emergency alert message was received, information regarding a tracking area or cell in which the wireless device received the emergency alert message, or information regarding the base station from which the wireless device received the emergency alert message.

Further aspects include a wireless device having a wireless transceiver and a processor coupled to the wireless transceiver and configured with processor-executable instructions to perform operations corresponding to any of the methods summarized above. Further aspects include a wireless device having means for performing functions corresponding to any of the methods summarized above. Further aspects include a non-transitory processor-readable storage medium having stored thereon processor-executable instructions configured to cause a processor of a wireless device to perform operations corresponding to any of the methods summarized above.

### BRIEF DESCRIPTION OF THE DRAWINGS

The accompanying drawings, which are incorporated herein and constitute part of this specification, illustrate example embodiments of the invention, and, together with the general description given above and the detailed description given below, serve to explain features of the invention.

FIGS. 1A and 1B are communication system block diagrams illustrating network components of example telecommunication systems suitable for use with various embodiments.

FIG. 1C is a data flow diagram illustrating an example of system information provisioning.

FIG. 2 is a component block diagram of an example computing system that could be configured to detect and respond to unauthorized emergency messages and unauthorized presidential alerts in accordance with the embodiments.

FIG. 3 is a component block diagram of an example software architecture including a radio protocol stack for the user and control planes in wireless communications.

FIG. 4 is a component block diagram of an example system 400 that includes an unauthorized base station that spoofs a base station of a network service provider and a signal overshadow attacker that could be used to send unauthorized presidential alerts or unauthorized emergency messages from the unauthorized base station to the wireless device.

FIGS. 5-8 are process flow diagrams illustrating methods of detecting and responding to unauthorized presidential alerts and unauthorized emergency messages in accordance with various embodiments.

FIGS. 9A and 9B are a component block diagrams illustrating an example system in which a server computing device may use information received from many wireless devices to detect and respond to unauthorized presidential alerts and unauthorized emergency messages in accordance with some embodiments.

FIG. 10 is a component block diagram of an example server computing device suitable for implementing various embodiments.

FIG. 11 is a component block diagram illustrating a wireless device suitable for implementing various embodiments.

### DETAILED DESCRIPTION

Various embodiments will be described in detail with reference to the accompanying drawings. Wherever possible, the same reference numbers will be used throughout the drawings to refer to the same or like parts. References made to particular examples and implementations are for illustrative purposes, and are not intended to limit the scope of the claims.

Various embodiments include methods, and components (e.g., server computing devices, wireless devices, etc.) configured to implement the methods, for detecting and responding to unauthorized alert messages, which for ease of reference is the general term used herein to refer to replayed presidential alerts, replayed emergency messages, unauthorized presidential alerts, and unauthorized emergency messages, as well as any other type of alert or emergency messages not broadcast by a legitimate authority.

In some embodiments, the wireless device may be configured to detect a broadcast from a base station of a first system information block (SIB1) that includes an alert message flag that indicates that an emergency alert message is scheduled for broadcast in another system information block (e.g., in one of SIBs 10-14, etc.), receive the emergency alert message from the base station, activate receiver circuitry to scan for SIB1 broadcasts from current neighbor base stations that are within communication range of the wireless device to receive an SIB1 broadcast by a current neighbor base station, determine whether the SIB1 broadcast by the current neighbor base station includes the alert message flag (e.g., an alert message bit, etc.) and determine whether the emergency alert message received from the base station is an unauthorized alert message (e.g., a replayed or fake emergency alert message, etc.) based on whether the SIB1 broadcast by the current neighbor base station includes the alert message flag.

In some embodiments, the wireless device may be configured to collect various different types of information (e.g., Cell ID, location, and other Cell identification information) from multiple (e.g., some or all) base stations with which the wireless device communicates, and store the collected information in a list of neighboring base stations (or “running set of neighboring eNodeBs”). In response to receiving an emergency alert message, the wireless device may generate and prioritize a “Neighbor Priority list for Additional Scanning” based on the information included in the list of neighboring base stations. The wireless device may sequentially traverse the “Neighbor Priority list for Additional Scanning” to select neighboring base stations based on their assigned priorities, and scan for the transmission of an emergency alert message from each of the selected base stations. The wireless device may determine or compute one or more valid alert values (e.g., a valid alert count, a valid alert probability value, etc.) and one or more unauthorized alert values based on whether the neighboring base stations transmit emergency alert messages and/or based on the degree to which the emergency alert messages transmitted from the neighboring base stations match the emergency alert message received from the base station to which the wireless device is attached. The wireless device may determine whether the emergency alert message received from the base station to which the wireless device is attached is an unauthorized alert message (e.g., a replayed or fake emergency alert message, etc.) based on the valid alert values and/or unauthorized alert values.

In some embodiments, the wireless device may be configured to work in conjunction with a server computing device (e.g., a crowdsourcing server, etc.) to detect and respond to an unauthorized alert message. For example, the wireless device may be configured to send the collected information, information indicating whether an emergency alert message was received, information identifying the type emergency alert message received, the wireless device's classification of a received emergency alert message as an unauthorized or valid message, the determined valid/unauthorized alert values, the content of the received emergency alert message, a message number associated with received emergency alert message, the geographic region in which the emergency alert message was received, information regarding the tracking area or cell in which the wireless device received the emergency alert message, information regarding the base station from which the wireless device received the emergency alert message, and other similar information to the server computing device.

The server computing device may be configured to receive the information from the wireless device, analyze the received information and/or compare the received information to similar information received from a multitude of other wireless devices to determine whether the emergency alert message is an unauthorized alert message. The server computing device may send the results of the analysis, comparison, or determination to the wireless device and/or other similarly situated devices (e.g., other devices in the same area as the wireless device, etc.). The wireless device may use the information received from the server to update its classification of the received emergency alert message, to detect other emergency alert messages, and/or to take other responsive actions.

In response to determining that the emergency alert message received from the base station is an unauthorized alert message (i.e., is a fake message, an attempted replay attack, etc.), the wireless device may take a responsive action, such as ignoring or discarding the emergency alert message, storing the message in memory and rendering an input screen that provides the user with an option to view the emergency alert message, displaying the emergency alert message and notifying the user the alert may not be authorized. For example, the wireless device may include in the display an indication that the alert is or could be unauthorized, that the alert is valid for other geographical areas but not the geographical area in which the device is currently located, that the alert has expired and no longer applies to the wireless device, that there is a high probability that the alert is malicious or part of a reply attack, that the alert cannot be validated, and similar notifications.

It should be understood that the response action may include any number of different actions or action combinations, and that nothing in the descriptions of various embodiments is intended to limit the responsive action to a specific action or combination of actions (e.g., displaying emergency alert message and notifying the user that the alert is unauthorized, discarding the emergency alert message and notifying the user that it may be have received a replay message, etc.) unless the specific action or combination of actions is expressly recited in the claims.

The contents of the notifications displayed as part of the response action (if any) may vary based on factors such as confidence scores, determinizations of whether the unauthorized alert is a replay attack, and for replay attacks whether the alert is determined to be invalid by the wireless device because of invalid time (expired alert), invalid location (out of alert area), or both invalid time and invalid location.

In some embodiments, the wireless device may be configured by the device user, the device manufacture or the telecommunications service provider to automatically determine the responsive action that is to be taken in response to determining that the emergency alert message received from the base station is an unauthorized alert message. In some embodiments, the wireless device may be configured to notify the device user, the device manufacturer, a carrier, the telecommunications service provider, an internet service provider, and/or another entity so that such individuals or entities can take responsive actions, which may include directing, setting or updating the response action(s) that are taken by the wireless device in response to determining that the emergency alert message received from the base station is an unauthorized alert message.

In some embodiments, the wireless device may be configured to select and perform the responsive action based on any or all of: the type emergency alert message received; the wireless device's classification of the received emergency alert message (e.g., replayed presidential alert, replayed emergency message, unauthorized presidential alert, unauthorized emergency message, etc.); the content of the received emergency alert message; the geographic region in which the emergency alert message was received; the tracking area or cell in which the wireless device received the emergency alert message; the timestamp associated with the received emergency alert message; and/or the base station from which the wireless device received the emergency alert message.

For example, in some embodiments, the wireless device may be configured to determine the responsive action that is to be taken based on whether the received emergency alert message is classified by the wireless device as a replay message. The wireless device may classify the emergency alert message as a replay message in response to determining that the difference between the timestamp associated with the received emergency alert message and the current time exceeds a threshold. As another example, the wireless device may classify the emergency alert message as a replay message in response to determining that the received emergency alert message is not valid in the geographic region in which the emergency alert message was received or the geographical region which the wireless device is currently located, but valid in other geographical regions.

A number of different cellular and mobile communication services and standards are available or contemplated in the future, all of which may implement and benefit from the various embodiments. Such services and standards include, e.g., third generation partnership project (3GPP), long term evolution (LTE) systems, third generation wireless mobile communication technology (3G), fourth generation wireless mobile communication technology (4G), fifth generation wireless mobile communication technology (5G), global system for mobile communications (GSM), universal mobile telecommunications system (UMTS), 3GSM, general packet radio service (GPRS), code division multiple access (CDMA) systems (e.g., cdmaOne, CDMA2000™), enhanced data rates for GSM evolution (EDGE), advanced mobile phone system (AMPS), digital AMPS (IS-136/TDMA), evolution-data optimized (EV-DO), and digital enhanced cordless telecommunications (DECT). Each of these technologies involves, for example, the transmission and reception of voice, data, signaling, and/or content messages. It should be understood that any references to terminology and/or technical details related to an individual telecommunication standard or technology are for illustrative purposes only, and are not intended to limit the scope of the claims to a particular communication system or technology unless specifically recited in the claim language.

The tell is “user equipment” and “wireless device” may be used interchangeably herein to refer to any one or all of internet-of-things (IOT) devices, cellular telephones, smartphones, personal or mobile multi-media players, personal data assistants (PDA's), laptop computers, tablet computers, ultrabooks, palm-top computers, wireless electronic mail receivers, multimedia Internet enabled cellular telephones, wireless gaming controllers, smart cars, connected vehicles, autonomous vehicles, and similar electronic devices which include a programmable processor, a memory and circuitry for sending and/or receiving wireless communication signals. While various embodiments are particularly useful in wireless devices, such as smartphones and tablets, the embodiments are generally useful in any electronic device that includes communication circuitry for accessing wireless Internet Protocol (IP) and data services through cellular and wireless communication networks.

The term “system on chip (SOC)” is used herein to refer to a single integrated circuit (IC) chip that contains multiple resources and/or processors integrated on a single substrate. A single SOC may contain circuitry for digital, analog, mixed-signal, and radio-frequency functions. A single SOC may also include any number of general purpose and/or specialized processors (digital signal processors, modem processors, video processors, etc.), memory blocks (e.g., ROM, RAM, Flash, etc.), and resources (e.g., timers, voltage regulators, oscillators, etc.). SOCs may also include software for controlling the integrated resources and processors, as well as for controlling peripheral devices.

The term “system in a package (SIP)” may be used herein to refer to a single module or package that contains multiple resources, computational units, cores and/or processors on two or more IC chips, substrates, or SOCs. For example, a SIP may include a single substrate on which multiple IC chips or semiconductor dies are stacked in a vertical configuration. Similarly, the SIP may include one or more multi-chip modules (MCMs) on which multiple ICs or semiconductor dies are packaged into a unifying substrate. A SIP may also include multiple independent SOCs coupled together via high speed communication circuitry and packaged in close proximity, such as on a single motherboard or in a single wireless device. The proximity of the SOCs facilitates high speed communications and the sharing of memory and resources.

The term “multicore processor” may be used herein to refer to a single integrated circuit (IC) chip or chip package that contains two or more independent processing cores (e.g., CPU core, Internet protocol (IP) core, graphics processor unit (GPU) core, etc.) configured to read and execute program instructions. A SOC may include multiple multicore processors, and each processor in an SOC may be referred to as a core. The term “multiprocessor” may be used herein to refer to a system or device that includes two or more processing units configured to read and execute program instructions.

The term “emergency alert message” is used herein to refer to presidential alerts, Earthquake and Tsunami Warning System (ETWS) messages, Commercial Mobile Alert System (CMAS) messages, Wireless Emergency Alert (WEA) messages, FM Radio National Public Radio (NPR) signal or other signals carrying audio alerts such as Satellite TV/Radio that could be included in passenger vehicles, or any similar alert or broadcast message included as part of the public warning system (PWS) or Integrated Public Alert and Warning System (IPAWS) which uses Common Alerting Protocol (CAP), which defines ‘circles and polygons’ as an option for defining localized regions. CMAS emergency messages may be used to notify users of presidential threats, immediate safety threats or child abduction alerts (Amber Alerts). Mobile network service providers usually prioritize and deliver emergency messages to their users within a certain time frame. Emergency messages may be delivered to all wireless device users within a predetermined notification area.

The phrase “capture effect” is used herein to refer a phenomenon associated with frequency modulated (FM) reception in telecommunication networks in which only the stronger of two signals (at least 4 dB higher signal strength) at or near the same frequency or channel is demodulated. The weaker signal is attenuated or completely suppressed in the demodulation stage or at the receiver limiter.

Some wireless devices include a subscriber identification module (SIM) hardware, memory, or card that stores information required by one or more radio systems (e.g., in a cellular communication network base station, etc.) to identify, authenticate, and/or locate the wireless device. The SIM may store one or more authentication keys, an international mobile subscriber identity (IMSI) value, a Temporary Mobile Subscriber Identity (TMSI) value, a location area code (LAC), a home public land mobile network (HPLMN) value, and other similar identification, authentication, or location information.

An IMSI value may be a sixty-four (64) bit field or a fifteen (15) digit number that serves as an identifier for the wireless device and network. The first three digits of an IMSI value may store a Mobile Country Code (MCC) value, the next three digits may store a Mobile Network Code (MNC) value, and the remaining nine (9) digits may store a Mobile Subscription Identification Number (MSIN). The combination of the MCC and MNC values may uniquely identify a specific cellular service provider (e.g., AT&T, Verizon, etc.) network and in a specific country. The MSIN value may uniquely identify the wireless device and/or the wireless device user.

The IMSI value includes sensitive identification information that may be used by nefarious actors to track the wireless device (and thus its user) or launch cyber-attacks (e.g., replay attacks, etc.). For security reasons, in LTE and other advanced communication networks, wireless devices typically only transmit their IMSI value during the initial random-access procedure in which they establish a connection to the network (e.g., after the wireless device is powered on, moved to a new network location, etc.). The wireless devices may be configured to initiate the initial random-access procedure in response to receiving an IMSI-based paging message from the communication network.

A TMSI value is a randomly assigned temporary identifier that may be used to uniquely identify and address a wireless device. The TMSI value may be assigned to a wireless device by a mobile switching center or visitor location register shortly after the initial random-access procedure. The TMSI value may be specific to the wireless device's current cell or tracking area, and updated each time the wireless device is moved to a new tracking area. For security purposes, the TMSI is the identity value that is most commonly communicated between the wireless device and the base stations.

A telecommunication network typically includes a plurality of base stations (e.g., eNodeBs in LTE), which may act as a bridge (e.g., layer 2 bridge) between the wireless devices and the network by serving as the termination point of all radio protocols towards the wireless devices, and relaying voice (e.g., VoIP, etc.), data, and control signals to network components within the network. Each base station generally covers a small geographical area. Groups of bases stations make up a location area, routing area, or tracking area (TA).

A base station may transmit broadcast messages using a broadcast and multicast control (BMC) protocol layer over a common traffic channel (CTCH). The broadcast messages may be sent using discontinuous reception (DRX) over the common traffic channel, and may be scheduled for transmission during certain radio frames. A cell broadcast service (CBS) allows cell broadcast messages to be sent to wireless devices and may be transmitted at a defined repetition interval.

When a wireless device is powered on or is moved into a new geographical area or TA, the wireless device performs cell search and selection operations, which may include detecting and decoding a primary synchronization signal (PSS) and a secondary synchronization signal (SSS) from a base station, from which it may also determine TDD vs FDD (which may indicate different carriers). The wireless device may receive and decode a physical broadcast channel (PBCH) to receive basic system configuration information in a master information block (MIB). The basic system configuration information may include system bandwidth information, the number of transmit antennas used by the base station, physical hybrid-ARQ indicator channel (PHICH) configuration information, a PHICH Ng value, a system frame number (SFN), and other similar information.

In addition, the wireless device may receive system configuration information in system information blocks (SIB). The SIBs may be transmitted as unprotected broadcast signals so that any device may receive, decode and read the SIBs without authentication. In US LTE systems, SIB 1 is repeatedly broadcast every 20 ms, and may include scheduling information (e.g., an alert message flag/bit that indicates that SIB12 is scheduled for broadcast, etc.), cell access information and cell selection information. SIB 2 may include access barring information, common channel configuration information, uplink frequency information, and Multimedia Broadcast Multicast Service (MBMS) over a Single Frequency Network (MBSFN) configuration information. SIBs 3-9 may include information/parameters for intra-frequency cell reselections, intra-frequency neighboring cells, inter-frequency neighboring cells, reselection information, and a home eNodeB name. SIBs 10 and 11 may include Earthquake and Tsunami Warning System (ETWS) information. SIB 12 may include Commercial Mobile Alerting System (CMAS) information. SIB 13 may include MBSFN (eMBMS) area configuration information and main control channel (MCCH) configuration information. SIB 14 may include extended access barring information. SIB 15 may include MBMS service area identities (SAI) configuration information. SIB 16 may include global positioning system (GPS) related information. SIB 17 may include interworking wireless local area network (I-WLAN) configuration information.

It should be understood that the format and types of information included in each SIB, as well as the number of SIBs broadcast in each cycle and/or for each MIB, may depend on the underlying network technology or the country in which the network is deployed. For ease of reference, the embodiments below are described with reference to the SIB standard used in US LTE systems. However, nothing in this application should be used to limit the scope of the claims or described embodiments to a US LTE system or a specific SIB structure unless expressly recited as such in the claims.

The various embodiments include components (e.g., base stations, wireless devices, etc.) configured to limit or prevent a malicious or nefarious actor from sending unauthorized presidential alerts and unauthorized emergency messages.

The embodiments may include a wireless device that is configured to collect various different types of information (e.g., Cell ID, location, PLMN, TDD/FDD, and other Cell identification information) from multiple (e.g., some or all) base stations with which the wireless device communicates, and store the collected information in a list of neighboring base stations (or “running set of neighboring eNodeBs”). For example, to identify non-host network cells, the wireless device may determine that some neighboring base stations are using time division duplex (TDD) and others are using frequency division duplex (FDD). The wireless device may determine that these different networks technologies (e.g., TDD vs. FDD) should be associated with different hosts.

As another example, during cell search, the wireless device may gather information from neighboring base stations irrespective of the public land mobile network value associated with the base station. That is, the wireless device may gather information from a neighboring base station even if the neighboring base station is associated with a different network operator or service provider. In addition, the wireless device may gather information from neighboring base stations during the authentication procedures, which may include information collected before, during or after the Authentication and Key Agreement (AKA) procedure, security context setup, etc. The wireless device may store or maintain such information in the list of neighboring base stations.

In some embodiments, the wireless device may be configured to categorize base stations into groups, and store the base stations in the list of neighboring base stations based on their associated categories/groups. For example, one group (e.g., group A) may include base stations that passed authentication and are associated with same operator network as the wireless device, and another group (e.g., group B) may include base stations that are from different operator networks. The base stations may also be further grouped, categorized or subcategorized based on a variety of other factors and criteria, such as geographical area (e.g., current geographical region in which the wireless device operates, etc.), time (e.g., the base stations with which the wireless device detected in the past X hours, etc.), region size (e.g., base stations seen in a certain sized region, etc.), number (e.g., last Y number of base stations detected, etc.), etc.

The wireless device may be configured to detect, decode and read a SIB1 and determine that an emergency alert message is scheduled for broadcast (e.g., SIB12 is scheduled for broadcast, an alert message flag is set for any of SIBs 10-14, etc.).

In response to determining that an emergency alert message is scheduled for broadcast, the wireless device may receive and decode the corresponding emergency alert message (e.g., in one of SIBs 10-14) to obtain a message number (e.g., message identifier value within the decimal range 4370 to 4399, 4352 to 4359, 4400-6399 etc.) and message content. The wireless device may also generate a “Neighbor Priority list for Additional Scanning” that includes all of the current neighbor base stations detected by the wireless device. In addition, the wireless device may access the list of neighboring base stations (“running set of neighboring eNodeBs”) to determine the groups to which the detected current neighbor base stations belong (e.g., Group A or B, etc.).

The wireless device may organize, prioritize or sort the detected current neighbor base stations in the “Neighbor Priority list for Additional Scanning” based on the groups to which the neighboring base stations belong (e.g., Group A or B, etc.). In some embodiments, the wireless device may assign a higher priority to those neighboring base stations of the same operator as the wireless device and that have passed AKA (e.g., Group A), and to assign a lower priority (or next highest priority) to the base stations from other operators (e.g., Group B), etc. In other embodiments, the wireless device may assign a higher priority to base stations from other operators, etc. A higher priority base station (when scanned) gives a higher confidence for detection.

In response to determining that an emergency alert message is scheduled (e.g., SIB12 is scheduled, etc.) and/or in response to generating, organizing, prioritizing or sorting the “Neighbor Priority list for Additional Scanning,” the wireless device may perform an explicit scan for a SIB1 and any or all of SIBs 10-14 broadcasted by any or all of the base stations included in the “Neighbor Priority list for Additional Scanning.” In some embodiments, the wireless device may be configured to perform the scan sequentially for each base station based on the position or priority of the base station in the “Neighbor Priority list for Additional Scanning.” Because there may be some delay between emergency alert messages sent by different operators, in some embodiments the wireless device may be configured to wait a predetermined amount of time between scanning base station that belong to different operators, and may if needed repeat a set number of times.

As part of the explicit scan, the wireless device may determine whether the alert message flag (e.g., an alert message bit, etc.) is set for any of SIBs 10-14 in any of the SIB 1 s broadcast by any of the base stations included in the “Neighbor Priority list for Additional Scanning.”

The wireless device may increase or increment one or more unauthorized alert values (count, score, and/or probability values) in response to determining that the alert message flag is not set for any of SIBs 10-14 in an SIB1. For example, the wireless device may increase or increment one or more of the unauthorized alert values in response to determining that the SIB1 of a base station included in the “Neighbor Priority list for Additional Scanning” does not include a bit that indicates SIB12 is scheduled for broadcast.

The wireless device may increase or increment one or more valid alert values (count, score, and/or probability values) in response to determining that the alert message flag is set for any of SIBs 10-14 in a SIB1. For example, the wireless device may increase or increment one or more of the valid alert values in response to determining that the SIB1 of a base station included in the “Neighbor Priority list for Additional Scanning” includes a bit that indicates SIB12 is scheduled for broadcast.

In addition, for the neighboring base stations that broadcast a SIB1 having an alert message flag set, the wireless device may read and decode the corresponding emergency alert message (e.g., in one of SIBs 10-14) to obtain a message number (message#) and message content to determine whether the emergency alert message sent from the neighboring base station is the same as the emergency alert message the wireless device received.

The wireless device may increase or increment one or more of the unauthorized alert values in response to determining that the emergency alert message sent from the neighboring base station is not the same as the emergency alert message received by the wireless device. That is, the wireless device may increase or increment one or more of the unauthorized alert values in response to determining that the emergency alert message sent from a neighboring base station is different from the emergency alert message that the wireless device received from the base station to which the wireless device is attached.

The wireless device may increase or increment one or more of the valid alert values in response to determining that the emergency alert message sent from the neighboring base station is the same as the emergency alert message received by the wireless device. That is, the wireless device may increase or increment one or more of the valid alert values in response to determining that the neighboring base station sent the same emergency alert message that the wireless device received from the base station to which the wireless device is attached.

In response to completing all or a portion of the explicit scan (e.g., after evaluating the SIB1 from first X number of neighboring base stations included in the “Neighbor Priority list for Additional Scanning,” etc.), the wireless device may evaluate or compare the valid alert values and the unauthorized alert values to determine whether the emergency alert message received from the base station to which the wireless device is attached is an unauthorized alert message. For example, in some embodiments the wireless device may determine whether a valid alert count value is zero, determine whether an unauthorized alert score or probability value exceeds (e.g., is greater than, etc.) a valid alert score or probability value, and classify the emergency alert message received from the base station to which the wireless device is attached as an unauthorized alert message in response to determining that the valid alert count value is zero and the unauthorized alert score/probability value exceeds the valid alert score/probability value.

In some embodiments, the wireless device may be configured to work in conjunction with a server computing device (e.g., a crowdsourcing server, etc.) to detect and respond to an unauthorized alert message. For example, the wireless device may be configured to send the collected information, information indicating whether an emergency alert message was received, information identifying the type emergency alert message received, the wireless device's classification of a received emergency alert message as an unauthorized or valid message and time stamped data from other cells used to make determination, the determined valid/unauthorized alert values, the content of the received emergency alert message, a message number associated with received emergency alert message, the geographic region in which the emergency alert message was received, information regarding the tracking area or cell in which the wireless device received the emergency alert message, information regarding the base station from which the wireless device received the emergency alert message, and other similar information to the server computing device. If the server receives data indicating a specific cell ID is showing both alert and no alert at the same time, the server may determine there is one or more fake or unauthorized base stations operating in the area. If it determines there is an Alert, then the area showing no alert has the fake or unauthorized base station. If it determines there is no Alert, then the areas receiving the alert have fake or unauthorized base stations sending the False Alert. If the server receives data indicating a specific Cell ID is showing an alert presence value (SIB12 scheduled in SIB1) in the same geographic area at the same time as other cells in the same public land mobile network (PLMN) but with a different value, the server may determine it is a fake or unauthorized base station.

The server computing device may be configured to receive the information from the wireless device, analyze the received information and/or compare the received information to similar information received from a multitude of other wireless devices. For example, the server computing device may evaluate the content and type of emergency alert message (e.g., a president's message, earthquake, tsunami, fire, Amber Alert, etc.) received by the wireless device to determine the intended or expected range of the message. Examples of intended or expected ranges of emergency alert messages that may be determined include one or more of city-wide, county-wide, state-wide, nationwide, or geometric shapes (e.g., a circle or polygon) as may be defined in the CAPS protocol for localized alerts. As another example the, the serving computer could look for multiple devices reporting the same Cell ID both with and without SIB1 scheduling SIB12 at the same time, indicating a likely rogue cell's ID, location, and unauthorized alert. As another example, the server computing device may generate metadata based on the alert type, the message contents, the time emergency alert message was sent, the location of the wireless device when it received the emergency alert message, base station information (e.g., PLMN, ID), etc. The server computing device may compare the generated metadata to metadata generated based on information received from other wireless devices that are in the same or similar location, geographic area, or cell as the wireless device to determine whether they are consistent or if the contents of messages are well correlated.

The server computing device may determine whether the emergency alert message is an unauthorized alert message based on the evaluation/comparison results. For example, the server computing device may determine that the emergency alert message is not an unauthorized alert message (is a valid emergency alert message) in response to determining that a large percentage of the wireless devices within intended/expected range of the message provided the server computing device with the same, similar or consistent information. The server computing device may determine that the emergency alert message is an unauthorized alert message in response to determining that only a small subset of devices that are within intended or expected range of the message (e.g., city-wide, county-wide, state-wide, nationwide, geometric shape as a circle or polygon such as defined in in the CAPS protocol for localized alerts, etc.) indicated to the server computing device that they received an emergency alert message.

The server computing device may send the results of its evaluations, analysis, comparisons, or determinations to the wireless device and/or other similarly situated wireless devices (e.g., other devices in the same area as the wireless device, etc.). The wireless device may use the information received from the server to update its classification of the received emergency alert message, to detect other emergency alert messages, and/or to take other responsive actions.

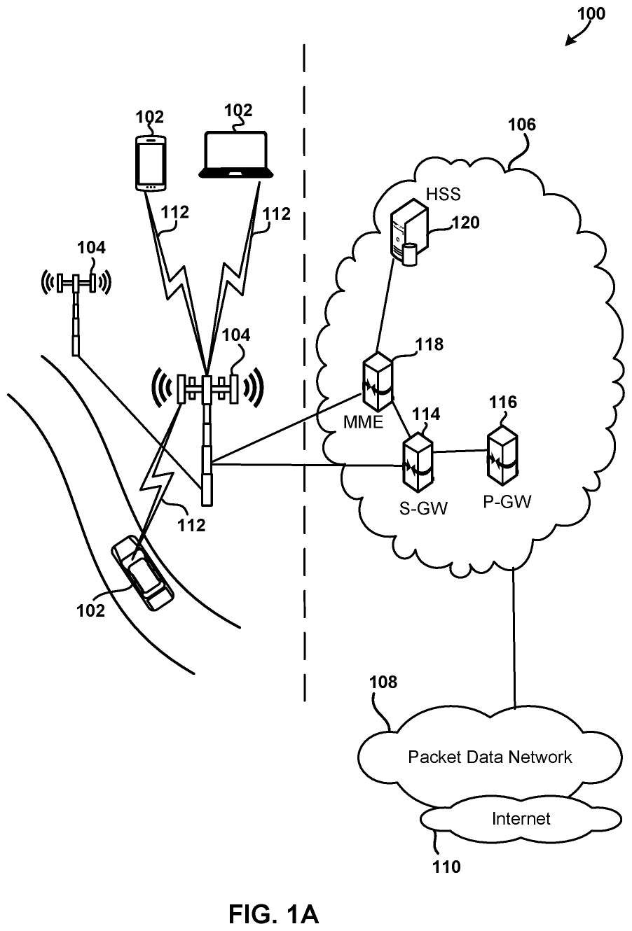

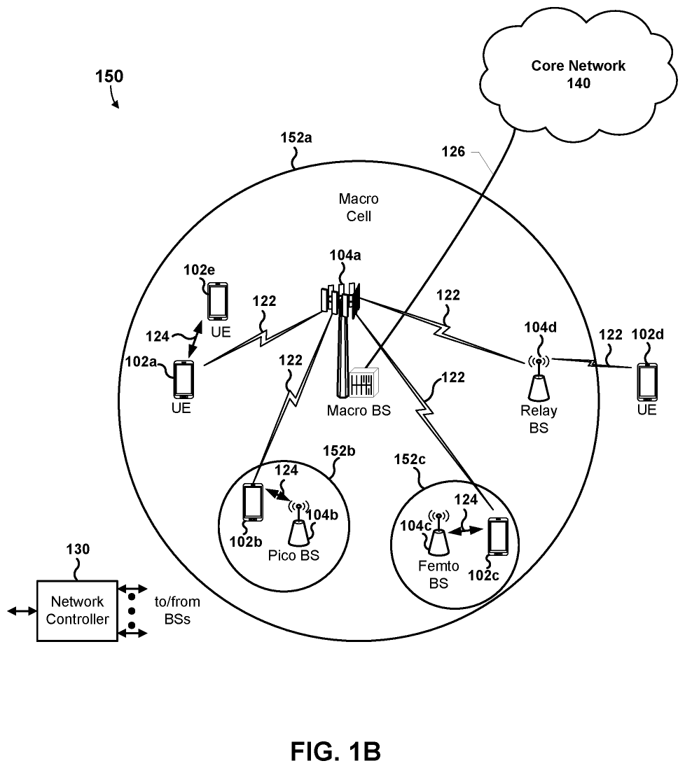

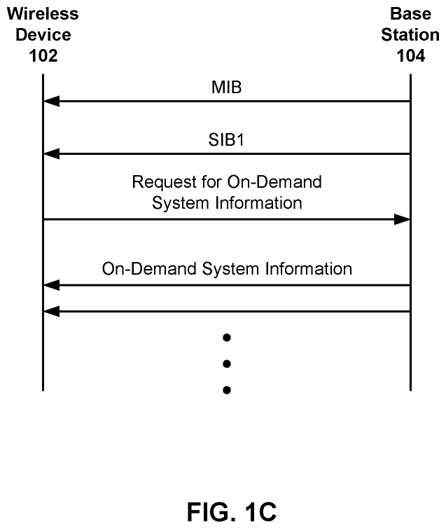

FIG. 1A illustrates an example Evolved Packet System (EPS), Long Term Evolution (LTE) or evolved universal terrestrial radio access network (E-UTRAN) communication network 100 in which the various embodiments may be implemented. In the example illustrated in FIG. 1, the network 100 includes wireless devices 102, base stations 104, and various network components 106 for communicating with a packet data network (PDN) 108 and ultimately the Internet 110. The PDN 108 may include an operator IP services network, an Intranet, an IP multimedia subsystem (IMS), a PS streaming service (PSS) network, etc.

The wireless devices 102 may be configured to transmit and receive voice, data, and control signals to and from the base stations 104 via wireless communication links 112. The base stations 104 may include an evolved Node B (eNodeB), a remote radio head (RRH), a femto cell, pico cell, micro cell, a base transceiver station (BTS), a radio base station, a radio transceiver, a transceiver function, a basic service set (BSS), an extended service set (ESS), etc.

The base stations 104 may be configured to provide user plane (e.g., PDCP, RLC, MAC, PHY) and control plane (RRC) protocol terminations towards the wireless devices 102. The base stations 104 may act as a bridge (e.g., layer 2 bridge) between the wireless devices 102 and the network components 106 by serving as the termination point of all radio protocols towards the wireless devices 102, and relaying voice (e.g., VoIP, etc.), data, and control signals to the network components 106 in the core network. The base stations 104 may also be configured to perform various radio resource management operations, such as controlling the usage of radio interfaces, allocating resources based on requests, prioritizing and scheduling traffic according to various quality of service (QoS) requirements, and monitoring the usage of network resources. In addition, the base stations 104 may be configured to collect radio signal level measurements, analyze the collected radio signal level measurements, and handover wireless devices 102 (or connections to the wireless devices) to other base stations 104 (e.g., a second eNodeB) based on the results of the analysis.

The network components 106 may include various logical and/or functional components that serve as the primary point of entry and exit of wireless device traffic and/or connect the wireless devices 102 to their immediate service provider, the PDN 108 and ultimately the Internet 110. The network components 106 may be configured to forward the voice, data, and control signals to other components in the core network as user data packets, provide connectivity to external packet data networks, manage and store contexts (e.g. network internal routing information, etc.), and act as an anchor between different technologies (e.g., 3GPP and non-3GPP systems). The network components 106 may also coordinate the transmission and reception of data to and from the Internet 110, as well as the transmission and reception of voice, data and control information to and from an external service network, the PDN 108, other base stations 104, and to other wireless devices 102.

In the example illustrated in FIG. 1A, data transmitted from the wireless devices 102 is received by a base station 104 (eNodeB). The base station 104 may send signaling/control information (e.g., information pertaining to call setup, security, authentication, etc.) to a mobility management entity (MME) 118. The MME 118 may request user/subscription information from a home subscriber server (HSS) 120, perform various administrative tasks (e.g., user authentication, enforcement of roaming restrictions, etc.), and send authorization and administrative information to the signaling gateway (SGW) 114 and/or the base station 104. The base station 104 may receive authorization information from the MME 118 (e.g., an authentication complete indication, an identifier of a selected SGW, etc.), and send data received from the wireless device 102 to the SGW 114. The SGW 114 may store information about the received data (e.g., parameters of the IP bearer service, etc.) and forward user data packets to a packet data network gateway (PGW) 116, which facilitates communications with the PDN 108 and ultimately the Internet 110.

The base stations 104 may be configured to manage the scheduling and transmission of paging messages originated from the MME 118, the scheduling and transmission of broadcast information originated from the MME 118, and the scheduling and transmission of public warning system (e.g., earthquake and tsunami warning system, commercial mobile alert service, etc.) messages originated from the MME 118.

The base stations 104 may be connected to the other base stations 104 via an X2 interface/protocol. The base stations 104 may be configured to communicate with the SGW 114 and/or MME 118 via the S1 interface/protocol.

The MME 118 may be configured to perform various operations to provide various functions, including non-access stratum (NAS) signaling, NAS signaling security, access stratum (AS) security control, inter-CN node signaling for mobility between 3GPP access networks, idle mode user equipment (UE) reach-ability (including control and execution of paging retransmission), tracking area list management (e.g., for a wireless device in idle and active mode), PGW and SGW selection, MME selection for handovers with MME change, Serving GPRS Service Node (SGSN) selection for handovers to 2G or 3G 3GPP access networks, roaming, authentication, bearer management functions including dedicated bearer establishment, support for public warning system (e.g., earthquake and tsunami warning system, commercial mobile alert service, etc.) message transmission, and performing paging optimization.

FIG. 1B illustrates another example of a communications system 150 that is suitable for implementing various implementations. The communications system 150 may be a 5G NR network, or any other suitable network such as an LTE network.

The communications system 150 may include a heterogeneous network architecture that includes a communication network 140 and a variety of wireless devices (illustrated as wireless device 102a-102e in FIG. 1). The communications system 150 also may include a number of base stations (illustrated as the BS 104a, the BS 104b, the BS 104c, and the BS 104d) and other network entities. A base station is an entity that communicates with wireless devices (mobile devices), and also may be referred to as an NodeB, a Node B, an LTE evolved nodeB (eNB), an access point (AP), a radio head, a transmit receive point (TRP), a New Radio base station (NR BS), a 5G NodeB (NB), a Next Generation NodeB (gNB), or the like. Each base station may provide communication coverage for a particular geographic area. In 3GPP, the term “cell” can refer to a coverage area of a base station, a base station subsystem serving this coverage area, or a combination thereof, depending on the context in which the term is used.

A base station 104a-104d may provide communication coverage for a macro cell, a pico cell, a femto cell, another type of cell, or a combination thereof. A macro cell may cover a relatively large geographic area (for example, several kilometers in radius) and may allow unrestricted access by wireless devices with service subscription. A pico cell may cover a relatively small geographic area and may allow unrestricted access by wireless devices with service subscription. A femto cell may cover a relatively small geographic area (for example, a home) and may allow restricted access by wireless devices having association with the femto cell (for example, wireless devices in a closed subscriber group (CSG)). A base station for a macro cell may be referred to as a macro BS. A base station for a pico cell may be referred to as a pico BS. A base station for a femto cell may be referred to as a femto BS or a home BS. In the example illustrated in FIG. 1, a base station 104a may be a macro BS for a macro cell 152a, a base station 104b may be a pico BS for a pico cell 152b, and a base station 104c may be a femto BS for a femto cell 152c. A base station 104a-104d may support one or multiple (for example, three) cells. The terms “eNB”, “base station”, “NR BS”, “gNB”, “TRP”, “AP”, “node B”, “5G NB”, and “cell” may be used interchangeably herein.

In some examples, a cell may not be stationary, and the geographic area of the cell may move according to the location of a mobile base station. In some examples, the base stations 104a-104d may be interconnected to one another as well as to one or more other base stations or network nodes (not illustrated) in the communications system 150 through various types of backhaul interfaces, such as a direct physical connection, a virtual network, or a combination thereof using any suitable transport network.

The communications system 150 also may include relay stations (such as relay BS 104d). A relay station is an entity that can receive a transmission of data from an upstream station (for example, a base station or a wireless device) and send a transmission of the data to a downstream station (for example, a wireless device or a base station). A relay station also may be a wireless device that can relay transmissions for other wireless devices. In the example illustrated in FIG. 1, a relay station 104d may communicate with the macro base station 104a and the wireless device 102d in order to facilitate communication between the macro base station 104a and the wireless device 102d. A relay station also may be referred to as a relay base station, a relay base station, a relay, etc.

The communications system 150 may be a heterogeneous network that includes base stations of different types, for example, macro base stations, pico base stations, femto base stations, relay base stations, etc. These different types of base stations may have different transmit power levels, different coverage areas, and different impacts on interference in communications system 150. For example, macro base stations may have a high transmit power level (for example, 5 to 40 Watts), whereas pico base stations, femto base stations, and relay base stations may have lower transmit power levels (for example, 0.1 to 2 Watts).

A network controller 130 may couple to a set of base stations and may provide coordination and control for these base stations. The network controller 130 may communicate with the base stations via a backhaul. The base stations also may communicate with one another, for example, directly or indirectly via a wireless or wireline backhaul.

The wireless devices 102a, 102b, 102c may be dispersed throughout communications system 150, and each wireless device may be stationary or mobile. A wireless device also may be referred to as an access terminal, a terminal, a mobile station, a subscriber unit, a station, etc. A wireless device 102a, 102b, 102c may be a cellular phone (for example, a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (for example, smart ring, smart bracelet)), an entertainment device (for example, a music or video device, or a satellite radio), a vehicular component or sensor, smart meters/sensors, industrial manufacturing equipment, a global positioning system device, or any other suitable device that is configured to communicate via a wireless or wired medium.

A macro base station 104a may communicate with the communication network 140 over a wired or wireless communication link 126. The wireless devices 102a, 102b, 102c may communicate with a base station 104a-104d over wireless communication links 122.

Wired communication links 126 may use a variety of wired networks (such as Ethernet, TV cable, telephony, fiber optic and other form is of physical network connections) that may use one or more wired communication protocols, such as Ethernet, Point-To-Point protocol, High-Level Data Link Control (HDLC), Advanced Data Communication Control Protocol (ADCCP), and Transmission Control Protocol/Internet Protocol (TCP/IP).

Wireless communication links 122, 124 may include a plurality of carrier signals, frequencies, or frequency bands, each of which may include a plurality of logical channels. The wireless communication links may utilize one or more radio access technologies (RATs). Examples of RATs that may be used in a wireless communication link include 3GPP LTE, 3G, 4G, 5G (such as NR), GSM, Code Division Multiple Access (CDMA), Wideband Code Division Multiple Access (WCDMA), Worldwide Interoperability for Microwave Access (WiMAX), Time Division Multiple Access (TDMA), and other mobile telephony communication technologies cellular RATs. Further examples of RATs that may be used in one or more of the various wireless communication links within the communication system 150 include medium range protocols such as Wi-Fi, LTE-U, LTE-Direct, LAA, MuLTEfire, and relatively short range RATs such as ZigBee, Bluetooth, and Bluetooth Low Energy (LE).

Certain wireless networks (such as LTE) utilize orthogonal frequency division multiplexing (OFDM) on the downlink and single-carrier frequency division multiplexing (SC-FDM) on the uplink. OFDM and SC-FDM partition the system bandwidth into multiple (K) orthogonal subcarriers, which are also commonly referred to as tones, bins, etc. Each subcarrier may be modulated with data. In general, modulation symbols are sent in the frequency domain with OFDM and in the time domain with SC-FDM. The spacing between adjacent subcarriers may be fixed, and the total number of subcarriers (K) may depend on the system bandwidth. For example, the spacing of the subcarriers may be 15 kHz and the minimum resource allocation (called a “resource block”) may be 12 subcarriers (or 180 kHz). Consequently, the nominal Fast File Transfer (FFT) size may be equal to 128, 256, 512, 1024 or 2048 for system bandwidth of 1.25, 2.5, 5, 10 or 20 megahertz (MHz), respectively. The system bandwidth also may be partitioned into subbands. For example, a subband may cover 1.08 MHz (i.e., 6 resource blocks), and there may be 1, 2, 4, 8 or 16 subbands for system bandwidth of 1.25, 2.5, 5, 10 or 20 MHz, respectively.

While descriptions of some implementations may use terminology and examples associated with LTE technologies, some implementations may be applicable to other wireless communications systems, such as a new radio (NR) or 5G network. NR may utilize OFDM with a cyclic prefix (CP) on the uplink (UL) and downlink (DL) and include support for half-duplex operation using time division duplex (TDD). A single component carrier bandwidth of 100 MHz may be supported. NR resource blocks may span 12 sub-carriers with a sub-carrier bandwidth of 75 kHz over a 0.1 millisecond (ms) duration. Each radio frame may consist of 50 subframes with a length of 10 ms. Consequently, each subframe may have a length of 0.2 ms. Each subframe may indicate a link direction (i.e., DL or UL) for data transmission and the link direction for each subframe may be dynamically switched. Each subframe may include DL/UL data as well as DL/UL control data. Beamforming may be supported and beam direction may be dynamically configured. Multiple Input Multiple Output (MIMO) transmissions with precoding also may be supported. MIMO configurations in the DL may support up to eight transmit antennas with multi-layer DL transmissions up to eight streams and up to two streams per wireless device. Multi-layer transmissions with up to two streams per wireless device may be supported. Aggregation of multiple cells may be supported with up to eight serving cells. Alternatively, NR may support a different air interface, other than an OFDM-based air interface.

Some wireless devices may be considered machine-type communication (MTC) or evolved or enhanced machine-type communication (eMTC) wireless devices. MTC and eMTC wireless devices include, for example, robots, drones, remote devices, sensors, meters, monitors, location tags, etc., that may communicate with a base station, another device (for example, remote device), or some other entity. A wireless node may provide, for example, connectivity for or to a network (for example, a wide area network such as Internet or a cellular network) via a wired or wireless communication link. Some wireless devices may be considered Internet-of-Things (IoT) devices or may be implemented as NB-IoT (narrowband Internet of things) devices. The wireless device 102 may be included inside a housing that houses components of the wireless device 102, such as processor components, memory components, similar components, or a combination thereof.

In general, any number of communications systems and any number of wireless networks may be deployed in a given geographic area. Each communications system and wireless network may support a particular radio access technology (RAT) and may operate on one or more frequencies. A RAT also may be referred to as a radio technology, an air interface, etc. A frequency also may be referred to as a carrier, a frequency channel, etc. Each frequency may support a single RAT in a given geographic area in order to avoid interference between communications systems of different RATs. In some cases, NR or 5G RAT networks may be deployed.

In some examples, access to the air interface may be scheduled, where a scheduling entity (for example, a base station) allocates resources for communication among some or all devices and equipment within the scheduling entity's service area or cell. The scheduling entity may be responsible for scheduling, assigning, reconfiguring, and releasing resources for one or more subordinate entities. That is, for scheduled communication, subordinate entities utilize resources allocated by the scheduling entity.

Base stations are not the only entities that may function as a scheduling entity. In some examples, a wireless device may function as a scheduling entity, scheduling resources for one or more subordinate entities (for example, one or more other wireless devices). In this example, the wireless device is functioning as a scheduling entity, and other wireless devices utilize resources scheduled by the wireless device for wireless communication. A wireless device may function as a scheduling entity in a peer-to-peer (P2P) network, in a mesh network, or another type of network. In a mesh network example, wireless devices may optionally communicate directly with one another in addition to communicating with the scheduling entity.

Thus, in a wireless communication network with a scheduled access to time-frequency resources and having a cellular configuration, a P2P configuration, and a mesh configuration, a scheduling entity and one or more subordinate entities may communicate utilizing the scheduled resources.

In some implementations, two or more wireless devices 102a-e (for example, illustrated as the wireless device 102a and the wireless device 102e) may communicate directly using one or more sidelink channels 124 (for example, without using a base station 104a-d as an intermediary to communicate with one another). For example, the wireless devices 102a-e may communicate using peer-to-peer (P2P) communications, device-to-device (D2D) communications, a vehicle-to-everything (V2X) protocol (which may include a vehicle-to-vehicle (V2V) protocol, a vehicle-to-infrastructure (V2I) protocol, or similar protocol), a mesh network, or similar networks, or combinations thereof. In this case, the wireless device 102a-e may perform scheduling operations, resource selection operations, as well as other operations described elsewhere herein as being performed by the base station 104a-d.

FIG. 1C illustrates an example of SI provisioning. To establish communication with a base station 104, a wireless device 102 may attempt to acquire SI from the base station 104. SI may be provided in one or more system information blocks, such a Master Information Block (MIB) and one or more System Information Blocks (SIBs). SI provides timing and structure information that enables the wireless device 102 to receive and decode further information from the base station 104 that enables the wireless device 102 for example, to access communications through the base station 104, cell access, to perform cell reselection, intra-frequency, inter-frequency and inter-RAT cell selection procedures, and other operations.

In 5G NR, certain system information, such as the MIB and a SIB1 message, are broadcast by a base station. In some implementations, additional SI may be broadcast as well. However, in some implementations, the additional SI (such as on-demand SI) may be transmitted by the base station in response to a request for the additional SI (such as a request for the on-demand SI). In some implementations, the broadcast SI (that is, the MIB or SIB1 messages) may include scheduling information to enable the wireless device 102 to request and receive the on-demand system information.

When a wireless device 102 is powered on, the wireless device 102 may perform a cell search and acquire one or more synchronization signals (such as a Primary Synchronization Signal (PSS) and a Secondary Synchronization Signal (SSS)) and a Physical Broadcast Channel (PBCH) from a base station 104. Using the synchronization signal(s) and information from the PBCH the wireless device 102 may receive, decode and store MIB message(s) from the base station 104. Using parameters from the decoded MIB, the wireless device 102 may receive and decode the SIB1 message. In some implementations, the SIB1 message may indicate that the base station 104 is configured to provide one or more on-demand SI messages. To acquire the on-demand SI messages, the wireless device 102 may send a request to the base station 104 for the one or more on-demand SI messages. In some implementations, sending the request for the one or more on-demand messages may be part of a Random Access Channel (RACH) request procedure.

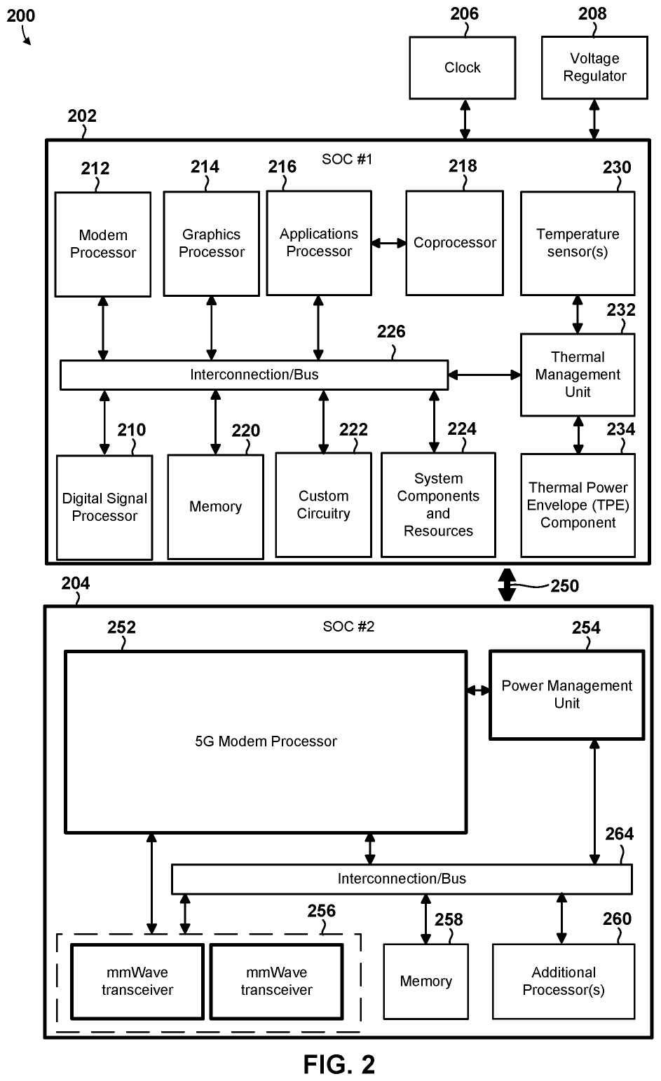

FIG. 2 illustrates an example computing system or SIP 200 architecture that may be used in wireless devices implementing the various implementations.

With reference to FIGS. 1A-2, the illustrated example SIP 200 includes a two SOCs 202, 204, a clock 206, and a voltage regulator 208. In some implementations, the first SOC 202 operate as central processing unit (CPU) of the wireless device that carries out the instructions of software application programs by performing the arithmetic, logical, control and input/output (I/O) operations specified by the instructions. In some implementations, the second SOC 204 may operate as a specialized processing unit. For example, the second SOC 204 may operate as a specialized 5G processing unit responsible for managing high volume, high speed (such as 5 Gbps, etc.), or very high frequency short wave length (such as 28 GHz mmWave spectrum, etc.) communications.

The first SOC 202 may include a digital signal processor (DSP) 210, a modem processor 212, a graphics processor 214, an application processor 216, one or more coprocessors 218 (such as vector co-processor) connected to one or more of the processors, memory 220, custom circuitry 222, system components and resources 224, an interconnection/bus module 226, one or more temperature sensors 230, a thermal management unit 232, and a thermal power envelope (TPE) component 234. The second SOC 204 may include a 5G modem processor 252, a power management unit 254, an interconnection/bus module 264, a plurality of mmWave transceivers 256, memory 258, and various additional processors 260, such as an applications processor, packet processor, etc.

Each processor 210, 212, 214, 216, 218, 252, 260 may include one or more cores, and each processor/core may perform operations independent of the other processors/cores. For example, the first SOC 202 may include a processor that executes a first type of operating system (such as FreeBSD, LINUX, OS X, etc.) and a processor that executes a second type of operating system (such as MICROSOFT WINDOWS 10). In addition, any or all of the processors 210, 212, 214, 216, 218, 252, 260 may be included as part of a processor cluster architecture (such as a synchronous processor cluster architecture, an asynchronous or heterogeneous processor cluster architecture, etc.).

The first and second SOC 202, 204 may include various system components, resources and custom circuitry for managing sensor data, analog-to-digital conversions, wireless data transmissions, and for performing other specialized operations, such as decoding data packets and processing encoded audio and video signals for rendering in a web browser. For example, the system components and resources 224 of the first SOC 202 may include power amplifiers, voltage regulators, oscillators, phase-locked loops, peripheral bridges, data controllers, memory controllers, system controllers, access ports, timers, and other similar components used to support the processors and software clients running on a wireless device. The system components and resources 224 or custom circuitry 222 also may include circuitry to interface with peripheral devices, such as cameras, electronic displays, wireless communication devices, external memory chips, etc.

The first and second SOC 202, 204 may communicate via interconnection/bus module 250. The various processors 210, 212, 214, 216, 218, may be interconnected to one or more memory elements 220, system components and resources 224, and custom circuitry 222, and a thermal management unit 232 via an interconnection/bus module 226. Similarly, the processor 252 may be interconnected to the power management unit 254, the mmWave transceivers 256, memory 258, and various additional processors 260 via the interconnection/bus module 264. The interconnection/bus module 226, 250, 264 may include an array of reconfigurable logic gates or implement a bus architecture (such as CoreConnect, AMBA, etc.). Communications may be provided by advanced interconnects, such as high-performance networks-on chip (NoCs).

The first or second SOCs 202, 204 may further include an input/output module (not illustrated) for communicating with resources external to the SOC, such as a clock 206 and a voltage regulator 208. Resources external to the SOC (such as clock 206, voltage regulator 208) may be shared by two or more of the internal SOC processors/cores.

In addition to the example SIP 200 discussed above, some implementations may be implemented in a wide variety of computing systems, which may include a single processor, multiple processors, multicore processors, or any combination thereof.

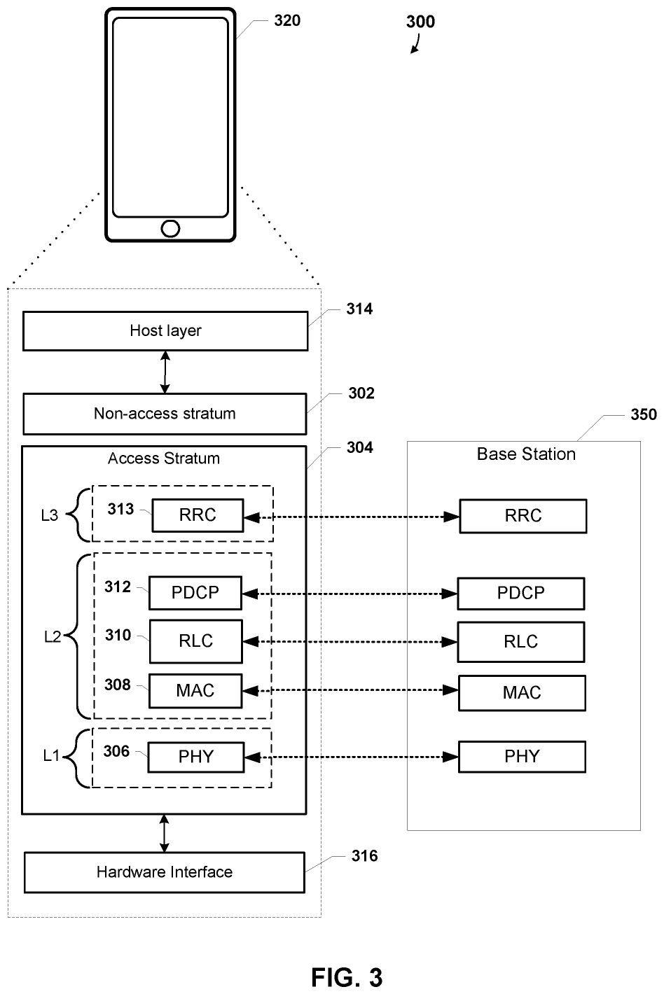

FIG. 3 illustrates an example of a software architecture 300 including a radio protocol stack for the user and control planes in wireless communications between a base station 350 (such as the base station 104a) and a wireless device 320 (such as the wireless devices 102a-e, 200). With reference to FIGS. 1A-3, the wireless device 320 may implement the software architecture 300 to communicate with the base station 350 of a communication system (such as 100). In various implementations, layers in software architecture 300 may form logical connections with corresponding layers in software of the base station 350. The software architecture 300 may be distributed among one or more processors (such as the processors 212, 214, 216, 218, 252, 260). While illustrated with respect to one radio protocol stack, in a multi-SIM (subscriber identity module) wireless device, the software architecture 300 may include multiple protocol stacks, each of which may be associated with a different SIM (such as two protocol stacks associated with two SIMs, respectively, in a dual-SIM wireless communication device). While described below with reference to LTE communication layers, the software architecture 300 may support any of variety of standards and protocols for wireless communications, or may include additional protocol stacks that support any of variety of standards and protocols wireless communications.

The software architecture 300 may include a Non-Access Stratum (NAS) 302 and an Access Stratum (AS) 304. The NAS 302 may include functions and protocols to support packet filtering, security management, mobility control, session management, and traffic and signaling between a SIM(s) of the wireless device (such as SIM(s) 204) and its core network. The AS 304 may include functions and protocols that support communication between a SIM(s) (such as SIM(s) 204) and entities of supported access networks (such as a base station). In particular, the AS 304 may include at least three layers (Layer 1, Layer 2, and Layer 3), each of which may contain various sub-layers.

In the user and control planes, Layer 1 (L1) of the AS 304 may be a physical layer (PHY) 306, which may oversee functions that enable transmission or reception over the air interface. Examples of such physical layer 306 functions may include cyclic redundancy check (CRC) attachment, coding blocks, scrambling and descrambling, modulation and demodulation, signal measurements, MIMO, etc. The physical layer may include various logical channels, including the Physical Downlink Control Channel (PDCCH) and the Physical Downlink Shared Channel (PDSCH).

In the user and control planes, Layer 2 (L2) of the AS 304 may be responsible for the link between the wireless device 320 and the base station 350 over the physical layer 306. In the various implementations, Layer 2 may include a media access control (MAC) sublayer 308, a radio link control (RLC) sublayer 310, and a packet data convergence protocol (PDCP) 312 sublayer, each of which form logical connections terminating at the base station 350.

In the control plane, Layer 3 (L3) of the AS 304 may include a radio resource control (RRC) sublayer 3. While not shown, the software architecture 300 may include additional Layer 3 sublayers, as well as various upper layers above Layer 3. In various implementations, the RRC sublayer 313 may provide functions INCLUDING broadcasting system information, paging, and establishing and releasing an RRC signaling connection between the wireless device 320 and the base station 350.

In various implementations, the PDCP sublayer 312 may provide uplink functions including multiplexing between different radio bearers and logical channels, sequence number addition, handover data handling, integrity protection, ciphering, and header compression. In the downlink, the PDCP sublayer 312 may provide functions that include in-sequence delivery of data packets, duplicate data packet detection, integrity validation, deciphering, and header decompression.

In the uplink, the RLC sublayer 310 may provide segmentation and concatenation of upper layer data packets, retransmission of lost data packets, and Automatic Repeat Request (ARQ). In the downlink, while the RLC sublayer 310 functions may include reordering of data packets to compensate for out-of-order reception, reassembly of upper layer data packets, and ARQ.

In the uplink, MAC sublayer 308 may provide functions including multiplexing between logical and transport channels, random access procedure, logical channel priority, and hybrid-ARQ (HARQ) operations. In the downlink, the MAC layer functions may include channel mapping within a cell, de-multiplexing, discontinuous reception (DRX), and HARQ operations.

While the software architecture 300 may provide functions to transmit data through physical media, the software architecture 300 may further include at least one host layer 314 to provide data transfer services to various applications in the wireless device 320. In some implementations, application-specific functions provided by the at least one host layer 314 may provide an interface between the software architecture and the general purpose processor 206.

In other implementations, the software architecture 300 may include one or more higher logical layer (such as transport, session, presentation, application, etc.) that provide host layer functions. For example, in some implementations, the software architecture 300 may include a network layer (such as IP layer) in which a logical connection terminates at a packet data network (PDN) gateway (PGW). In some implementations, the software architecture 300 may include an application layer in which a logical connection terminates at another device (such as end user device, server, etc.). In some implementations, the software architecture 300 may further include in the AS 304 a hardware interface 316 between the physical layer 306 and the communication hardware (such as one or more radio frequency transceivers).

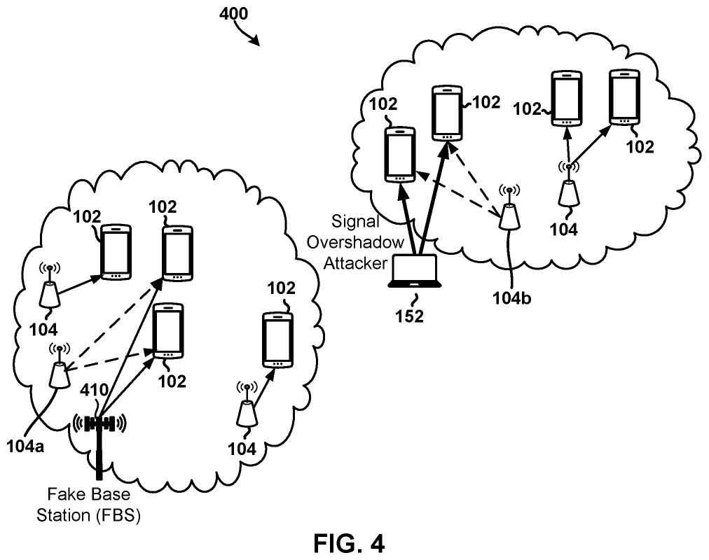

FIG. 4 illustrates examples of a base station 104, fake or unauthorized base station 410 and signal overshadow attacker 152. With reference to FIG. 4, a wireless device 102 may enter the idle mode. While operating in the idle mode, the wireless device 102 does not actively monitor the network for communications. Rather, the wireless device 102 activates its receiver circuitry on each paging occasion to listen to a shared paging channel to determine whether it received a paging message that includes a UE's TMSI or the wireless device's IMSI value that matches the information stored in memory or the wireless device's SIM. The wireless device 102 may exit the idle mode and/or attach to the base station 104 to receive call, message, or service in response to determining that it received a paging message during the paging occasion, and the paging message includes a wireless device's TMSI or IMSI value that matches the information stored on the wireless device's SIM.

The base station 104 may broadcast a paging message with UE's TMSI value during a paging occasion of a DRX cycle. The TMSI value is a temporary identifier and enhances security, unlike the IMSI which is a permanent identifier, and reduces the possibilities that a nefarious actor or a rogue base station could use to track the user or launch an attack. However, as per the 3GPP protocol standard paging with IMSI is an option that is available since at times when the core cellular network is not aware of the TMSI of a UE, it needs to page the UE with its IMSI. This available option of IMSI-based paging in the 3GPP standards may be exploited by a rogue base station 410 or other fake or unauthorized base stations.

As a result, a wireless device 102 could receive unauthorized or empty IMSI-based paging messages in multiple or all radio subframes, in multiple or all radio frames within the DRX cycles, and in one or more subsequent DRX cycles, and hence observe the IMSI-based paging message to be present in its paging occasion or also in other subframes when the modem is awake just before and after the paging occasion. If the IMSI value matches the information stored in memory, the wireless device 102 may initiate the random access procedure and attach to the rogue base station 410, which could then send unauthorized emergency messages/alerts.

If the rogue base station 410 was able to acquire the wireless device's 102 IMSI (e.g., via an IMSI leak attack beforehand), the rogue base station could set the other fields of the paging record similar to an original paging message. Upon receiving the paging message with IMSI, the wireless device 102 would disconnect from the currently connected network and then send an ATTACH_REQUEST message to the rogue base station 410.

In addition, the rogue base station 410 could inject unauthorized emergency paging messages and send them to a large number of wireless devices. These paging messages could have empty records but with unauthorized emergency warnings. To achieve a large reach, the rogue base station 410 could repeatedly broadcast in multiple or all radio subframes, in multiple or all radio frames within the DRX cycles, for one or more DRX cycles, while spoofing the system parameters of the legitimate base station 104. This type of attack could create artificial emergency situations and cause public disorder.

For all these reasons, a nefarious actor or a rogue base station 410 could utilize the paging features of existing communication networks to disrupt or hinder wireless devices from receiving the services provided by the communication network and/or service provider, thereby degrading the user experience. Further, in recent years, the cost and effort required to launch such attacks have reduced drastically with the availability of SDR and Universal Software Radio Peripheral (USRP) boards that can be carried with the equipment (kept in a backpack, etc.). The availability of open source LTE/3G stacks allows a nefarious actor to implement the rogue base station 410 via a laptop computer. As a result, the prevalence or likelihood of such attacks is expected to increase.

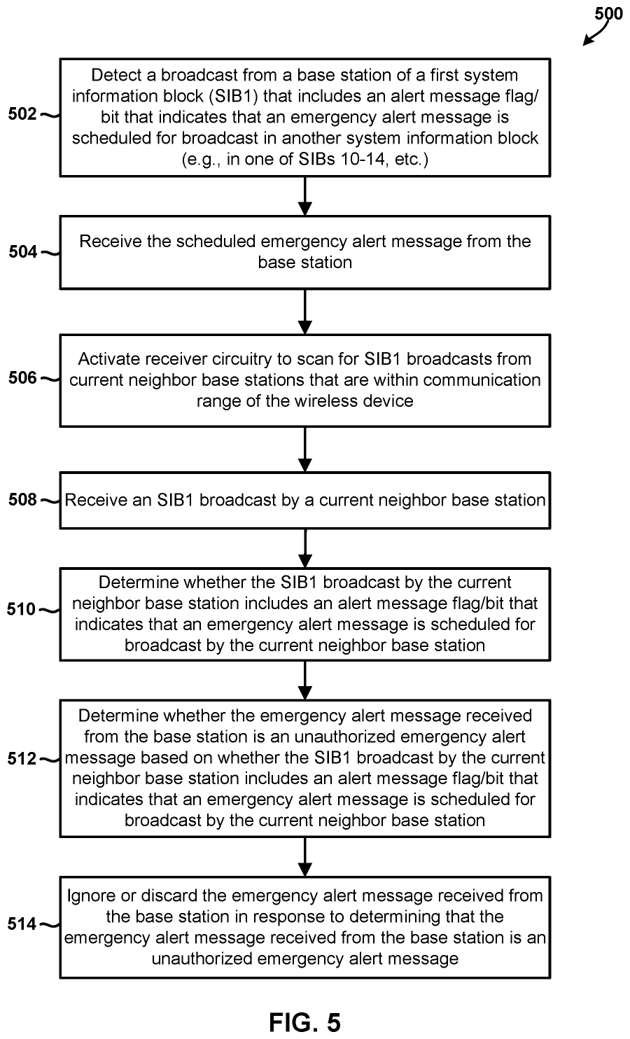

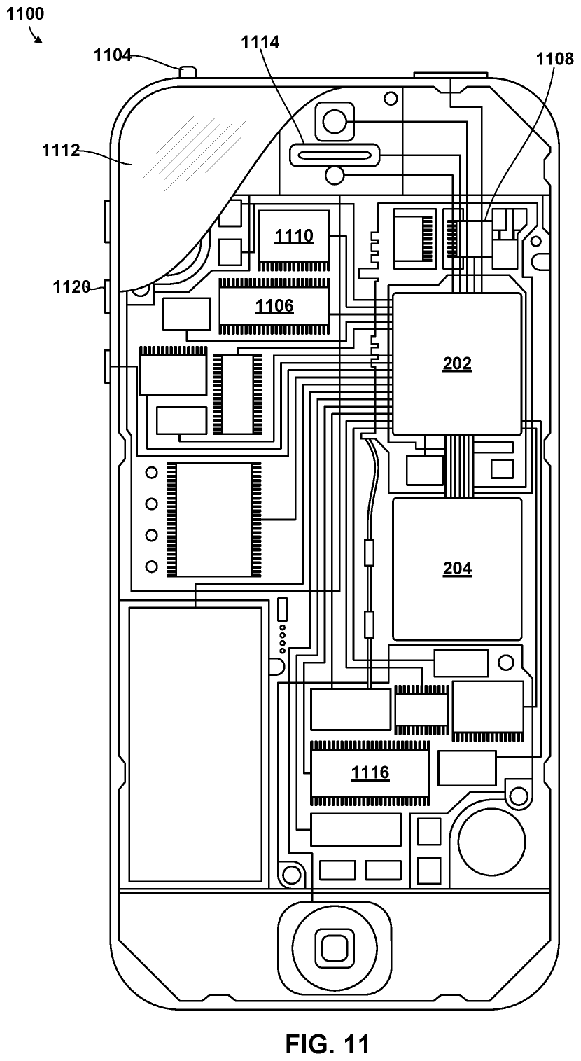

FIG. 5 illustrates a method 500 of detecting and responding to unauthorized presidential alerts and unauthorized emergency messages in accordance with some embodiments. The method 500 may be performed by a processor, such as an SOC 202, 204 or processor 212, 214, 218, 252 and/or 260 of a SIP 200 (FIG. 2), in a wireless device, such as wireless device 102 (FIGS. 1A-1C and 4), wireless device 320 (FIG. 3), or wireless device 1100 (FIG. 11).

In block 502, a processor in a wireless device may detect a broadcast from a base station. The broadcast may include a first system information block (SIB1) that includes an alert message flag (or an alert message bit, Boolean, or any similar value or unit of information suitable for communicating information for a binary or non-binary condition, etc.). The alert message flag may indicate that an emergency alert message is scheduled for broadcast in another system information block (e.g., in one of SIBs 10-14, etc.). In some embodiments, the alert message flag may be a bit (e.g., an alert message bit), Boolean value, or any other unit of information suitable for indicating that the emergency alert message is scheduled for broadcast in another system information block. In addition to the processor (e.g., SOC 202, 204 or processor 212, 214, 218, 252 and/or 260), a means for performing functions involved in the operations in block 502 may include an antenna (e.g., 1104, FIG. 11) coupled to a transceiver (e.g., 1108, FIG. 11).

In block 504, the wireless device processor may receive the scheduled emergency alert message from the base station. The emergency alert message may be received at the scheduled time according to standard methods and protocols, and stored in memory. In addition to the processor (e.g., SOC 202, 204 or processor 212, 214, 218, 252 and/or 260), a means for performing functions involved in the operations in block 504 may include an antenna (e.g., 1104, FIG. 11) coupled to a transceiver (e.g., 1108, FIG. 11).

In block 506, the wireless device processor may activate receiver circuitry to scan for SIB1 broadcasts from neighboring base stations that are within communication range of the wireless device (referred to as “current neighbor base stations”). In the context of cloud communications, the wireless device processor may scan for SIB1 broadcasts from neighboring base stations that are within 2-way communication range or within the receiving base station's transmissions range. For passive detection, which may only require 1-way (i.e., receive-only) communications and/or have a much greater coverage area, the wireless device processor may scan for SIB1 broadcasts from neighboring base stations that are within receive-only communication range. In some embodiments, the wireless device processor may determine that a neighbor base station is within communication range of the wireless device in response to detecting and successfully decoding a communication message or signal (e.g., direct message, unicast message, broadcast message, multicast message, IP message, etc.) from the base station. In addition to the processor (e.g., SOC 202, 204 or processor 212, 214, 218, 252 and/or 260), a means for performing functions involved in the operations in block 506 may include an antenna (e.g., 1104, FIG. 11) coupled to a transceiver (e.g., 1108, FIG. 11).

In block 508, the wireless device processor may receive an SIB1 message broadcast by a current neighbor base station. For example, the wireless device processor may determine that signals (e.g., receive-only message signals) are received and the included information is successfully decoded (e.g., with a bit error rate low enough that the information can be recovered after error correction processing). In some instances, the wireless device processor may receive SIB1 messages broadcast by multiple neighboring base stations. In addition to the processor (e.g., SOC 202, 204 or processor 212, 214, 218, 252 and/or 260), a means for performing functions involved in the operations in block 508 may include an antenna (e.g., 1104, FIG. 11) coupled to a transceiver (e.g., 1108, FIG. 11).

In block 510, the wireless device processor may determine whether the received SIB1 message broadcast by the current neighbor base station includes an alert message flag that indicates that an emergency alert message is scheduled for broadcast by the current neighbor base station. For example, the processor may inspect the bit, Boolean or other unit of information in the location within the received SIB1 message that is allocated to the alert message flag to determine whether that bit/Boolean indicates that an emergency alert message is scheduled to determine (e.g., whether the bit is set). In instances in which multiple SIB1 messages are received from multiple neighboring base stations, the processor may inspect the alert message flag in multiple SIB1 messages. In addition to the processor (e.g., SOC 202, 204 or processor 212, 214, 218, 252 and/or 260), means for performing functions involved in the operations in block 502 may include memory (e.g., 220 or 258 in FIG. 2; 1106 or 1116 in FIG. 11).

In block 512, the wireless device processor may determine whether the emergency alert message received from the base station is an unauthorized alert message based on whether the SIB1 message broadcast by the current neighbor base station includes an alert message flag that indicates that an emergency alert message is scheduled for broadcast. For example, if a SIB1 message received from the current neighbor base station includes an alert message flag that indicates that an emergency alert message is not scheduled for broadcast, the processor may determine that the emergency alert message received from the base station is an unauthorized alert message. As another example, if a SIB1 message received from the current neighbor base station includes an alert message flag that indicates that an emergency alert message is scheduled for broadcast, the processor may determine that the emergency alert message received from the base station is a legitimate emergency alert message. In instances in which multiple SIB1 messages are received from multiple neighboring base stations, the processor may make this determination based on alert message flag states in multiple SIB1 messages. In addition to the processor (e.g., SOC 202, 204 or processor 212, 214, 218, 252 and/or 260), means for performing functions involved in the operations in block 502 may include memory (e.g., 220 or 258 in FIG. 2; 1106 or 1116 in FIG. 11).

In block 514, the wireless device processor may ignore or discard the emergency alert message received from the base station in response to determining that the emergency alert message received from the base station is an unauthorized alert message. Also, in block 514, the wireless device processor may display and announce the emergency alert message in the standard manner in response to determining that the emergency alert message received from the base station is a legitimate emergency alert message. In addition to the processor (e.g., SOC 202, 204 or processor 212, 214, 218, 252 and/or 260), means for performing functions involved in the operations in block 502 may include a display (e.g., 1112 in FIG. 11) and memory (e.g., 220 or 258 in FIG. 2; 1106 or 1116 in FIG. 11).

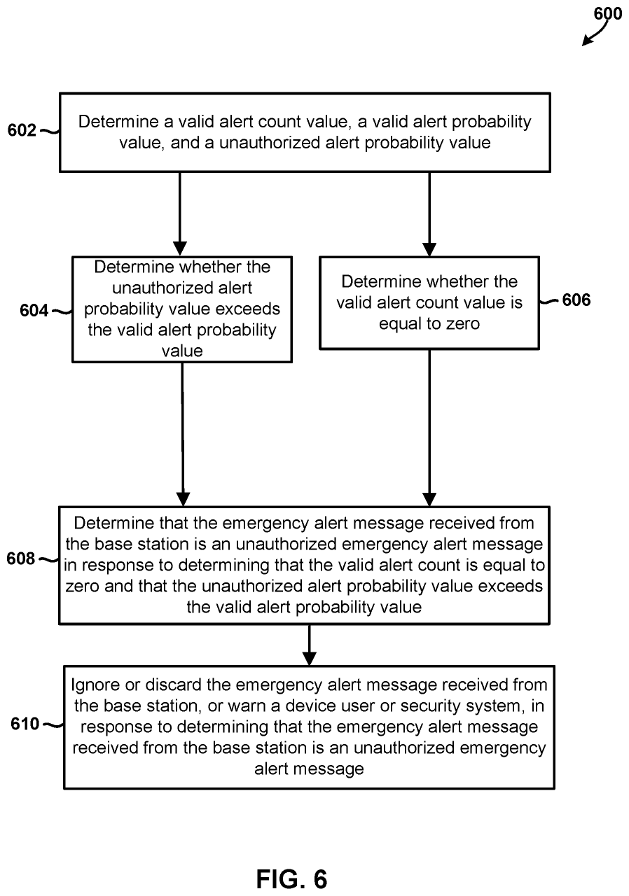

FIG. 6 illustrates a method 600 of detecting unauthorized presidential alerts and unauthorized emergency messages in accordance with an embodiment. The method 600 may be performed by a processor in wireless device (e.g., wireless device 102 illustrated in FIGS. 1A-1C and 4, SIP 200 illustrated in FIG. 2, wireless device 320 illustrated in FIG. 3, wireless device 1100 illustrated in FIG. 11, etc.).

In block 602, a processor in a wireless device may determine a valid alert count value, a valid alert probability value, and an unauthorized alert probability value. For example, the wireless device may increase or increment one or more unauthorized alert values (count, score, and/or probability values) in response to determining that the alert message flag is not set for any of SIBs 10-14 in an SIB1. For example, the wireless device may increase or increment one or more of the unauthorized alert values in response to determining that the SIB1 of a base station included in the “Neighbor Priority list for Additional Scanning” does not include a bit that indicates SIB12 is scheduled for broadcast.

Also in block 602, the wireless device may increase or increment one or more valid alert values (count, score, and/or probability values) in response to determining that the alert message flag is set for any of SIBs 10-14 in a SIB1. For example, the wireless device may increase or increment one or more of the valid alert values in response to determining that the SIB1 of a base station included in the “Neighbor Priority list for Additional Scanning” includes a bit that indicates SIB12 is scheduled for broadcast.

Also in block 602, the wireless device may increase or increment one or more of the unauthorized alert values in response to determining that the emergency alert message sent from the neighboring base station is not the same as the emergency alert message received by the wireless device. That is, the wireless device may increase or increment one or more of the unauthorized alert values in response to determining that the emergency alert message sent from a neighboring base station is different from the emergency alert message that the wireless device received from the base station to which the wireless device is attached.

Also in block 602, the wireless device may increase or increment one or more of the valid alert values in response to determining that the emergency alert message sent from the neighboring base station is the same as the emergency alert message received by the wireless device. That is, the wireless device may increase or increment one or more of the valid alert values in response to determining that the neighboring base station sent the same emergency alert message that the wireless device received from the base station to which the wireless device is attached.

In block 604, the wireless device processor may determine whether the unauthorized alert probability value exceeds the valid alert probability value. In other words, the processor may determine whether the determinations made in block 602 indicate that the probability is greater that the alert message is unauthorized than that the alert message is legitimate. For example, the processor may subtract the valid alert probability value from the unauthorized alert probability value and determine whether the remainder is greater than zero.

In block 606, the wireless device processor may determine whether the valid alert count value is equal to zero. In other words, the processor may determine whether any valid alerts have been recognized as recorded in a counter that is incremented each time a valid alert is detected.

In block 608, the wireless device processor may determine that the emergency alert message received from the base station is an unauthorized alert message in response to determining that the valid alert count is equal to zero and that the unauthorized alert probability value exceeds the valid alert probability value.

In block 610, the wireless device processor may ignore or discard the emergency alert message received from the base station in response to determining that the emergency alert message received from the base station is an unauthorized alert message. Alternatively or in addition, in block 610, the wireless device processor may warn the user or send a communication message to a security system that the emergency alert message received from the base station is an unauthorized emergency message, such as by displaying a warning message, emitting a warning sound, shaking or a combination of any such alert formats. On the other hand, in block 610, the processor may display and announce the emergency alert message in the standard manner, as well as increment the valid alert count, in response to determining that the emergency alert message received from the base station is a legitimate or valid emergency alert message.

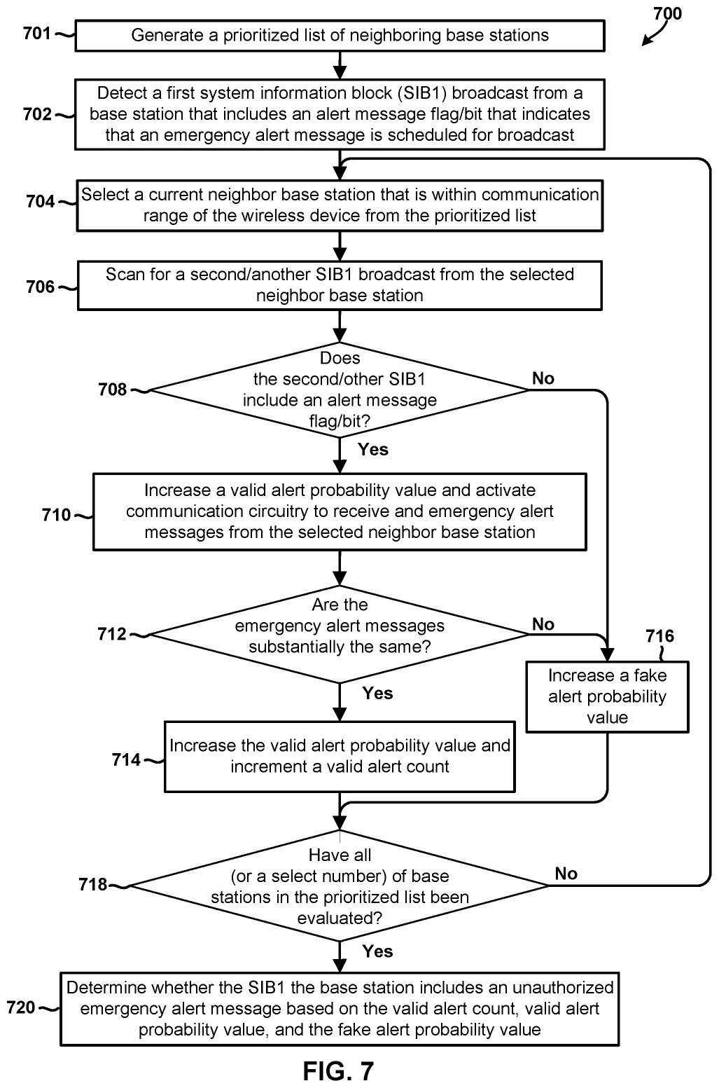

FIG. 7 illustrates a method 700 of detecting unauthorized presidential alerts and unauthorized emergency messages in accordance with an embodiment. The method 700 may be performed by a processor in wireless device (e.g., wireless device 102 illustrated in FIGS. 1A-1C and 4, SIP 200 illustrated in FIG. 2, wireless device 320 illustrated in FIG. 3, wireless device 1100 illustrated in FIG. 11, etc.).

In block 701, a processor of a wireless device may generate a “Neighbor Priority list for Additional Scanning” that includes all of the current neighbor base stations detected by the wireless device. The wireless device may organize, prioritize or sort the detected current neighbor base stations in the “Neighbor Priority list for Additional Scanning” based on the groups to which the neighboring base stations belong (e.g., Group A or B, etc.). In some embodiments, the wireless device may assign a higher priority to those neighboring base stations of the same operator as the wireless device and that have passed AKA (e.g., Group A), and to assign a lower priority (or next highest priority) to the base stations from other operators (e.g., Group B), etc. In other embodiments, the wireless device may assign a higher priority to base stations from other operators, etc. A higher priority base station (when scanned) gives a higher confidence for detection.

In block 702, the processor in the wireless device may detect a SIB1 message broadcast from a base station that includes an alert message flag that indicates that an emergency alert message is scheduled for broadcast. For example, the processor of the wireless device may inspect SIB1 messages received from the base station on which the wireless device is camped and detect when the alert message flag in an SIB1 message is set.

In block 704, the wireless device processor may select a current neighbor base station that is within communication range of the wireless device from the prioritized list. The wireless device processor may access the list of base stations generated in block 701 and stored in memory to identify one or more base stations to tune to detect signals.

In block 706, the wireless device processor may scan the signals from the selected neighboring base station for a second or another SIB1 broadcast by the selected neighbor base station. As part of scanning the selected neighboring base station, the processor may indicate in the prioritized list that has been scanned, such as by labeling the base station as scanned.

In determination block 708, the wireless device processor may determine whether the second/other SIB1 includes an alert message flag that indicates that an emergency alert message is scheduled for broadcast by the selected neighbor base station. Similar to the operations in block 510 of the method 500, the processor may inspect the bit, Boolean or other unit of information in the location within the received SIB1 message that is allocated to the alert message flag to determine whether that bit/Boolean indicates that an emergency alert message is scheduled to determine (e.g., whether the bit is set).

In response to determining that the second/other SIB1 includes an alert message flag that indicates that an emergency alert message is scheduled for broadcast by the selected neighbor base station (i.e., determination block 708=“Yes”), the wireless device processor may increase a valid alert probability value and activate communication circuitry to receive any emergency alert messages from the selected neighbor base station in block 710. In other words, having determined that the selected neighbor base station also indicates that an emergency alert message is scheduled, the processor may perform operations to receive that message at the scheduled time.

In determination block 712, the wireless device processor may compare the emergency alert message received from the selected neighbor base station (current neighbor base station) to the emergency alert message received from the base station to determine whether the emergency alert messages are substantially the same. In response to determining that the emergency alert messages are substantially the same (i.e., determination block 712=“Yes”), the wireless device processor may increase the valid alert probability value and increment a valid alert count in block 714.

In response to determining that the second/other SIB1 does not include an alert message flag that indicates that an emergency alert message is scheduled for broadcast by the selected neighbor base station (i.e., determination block 708=“No”) or in response to determining that the emergency alert messages are not substantially the same (i.e., determination block 712=“No”), the wireless device processor may increase an unauthorized alert probability value in block 716. The unauthorized alert probability may be a fraction or probability value indicative of the likelihood that the received emergency alert message is unauthorized.

In determination block 718, the wireless device processor may determine whether all (or a select number) of the base stations included in the prioritized list have been scanned and/or evaluated.

In response to determining that all (or a select number) of the base stations included in the prioritized list been have not been scanned and/or evaluated (i.e., determination block 718=“No”), the wireless device processor may select the next highest priority unevaluated or unscanned base station in the prioritized list that is within communication range of the wireless device in block 704, and perform the operations in blocks 706-718 until all (or the select number) of the base stations includes in the prioritized list been have been scanned and/or evaluated. In this manner, the processor may receive SIB1 messages and emergency alert messages from all or selected neighboring base stations, compare received emergency alert messages and determine a count and probability of an unauthorized alert messages based on a survey of the neighboring base stations.

In response to determining that all (or the select number) of the base stations included in the prioritized list been have been scanned and/or evaluated (i.e., determination block 718=“Yes”), the wireless device processor may determine whether the SIB1 from the base station includes an unauthorized alert message based on the valid alert count, valid alert probability value, and the unauthorized alert probability value in block 720. Thus, the processor may base the determination of whether a received emergency alert message is unauthorized based on the survey of multiple neighboring base station. Basing the determination of whether an emergency alert message is unauthorized or valid on a survey of neighboring base stations enables the processor to identify an unauthorized alert messages that are being broadcast by more than one fake or unauthorized base station, as well as receive and render and announce valid emergency alert message broadcast by other base stations in the area. Also, basing the determination of whether an emergency alert message is unauthorized or valid on a survey of neighboring base stations enables the processor to determine that a received emergency alert message is in fact valid and should be announced on the wireless device when a neighboring fake or unauthorized base station is not broadcasting the same message (i.e., not indicating in the SIB1 that an alert message is scheduled or broadcasting an unauthorized message).

Some embodiments may include methods of detecting and responding to unauthorized presidential alerts and unauthorized emergency messages by a server computing device. Such embodiments may include the server receiving information collected or determined by a wireless device, in which such information was collected or determined by the wireless device in response to the wireless device detecting a broadcast from a base station of first system information block (SIB1) that included an alert message flag that indicated that an emergency alert message is scheduled for broadcast in another system information block, the server analyzing the information received from the wireless device to generate an analysis result, the server comparing the information received from the wireless device to information received from a plurality of other wireless devices to generate a comparison result, the server determining whether the emergency alert message is an unauthorized alert message based on at least one of the analysis result or the comparison result, and the server sending at least one of the analysis result, the comparison result, or an indication of whether the emergency alert message is an unauthorized alert message to wireless devices.

In some embodiments, analyzing the information received from the wireless device to generate the analysis result may include the server evaluating a content or a type of emergency alert message (e.g., a president's message, earthquake, tsunami, fire, Amber Alert, etc.) received by the wireless device to determine an intended or expected range of the emergency alert message, such as city-wide, county-wide, state-wide, nationwide, or geometric shape (e.g., a circle or polygon) defined in the Common Alerting Protocol (CAPS) for localized alerts, etc.). In some embodiments, analyzing the information received from the wireless device to generate the analysis result may include the server analyzing at least one of an alert type, a message content, a time that the emergency alert message was sent, a location of the wireless device when it received the emergency alert message, base station information (e.g., PLMN, ID), etc. In some embodiments, comparing the information received from the wireless device to information received from the plurality of other wireless devices to generate the comparison result may include the server determining whether information received from the wireless device is consistent with information received from the other wireless devices, determining whether the emergency alert message is a same type of message as emergency alert messages received by the other wireless devices, or determining whether contents of the emergency alert message are correlated with contents of emergency alert messages received by the other wireless devices.

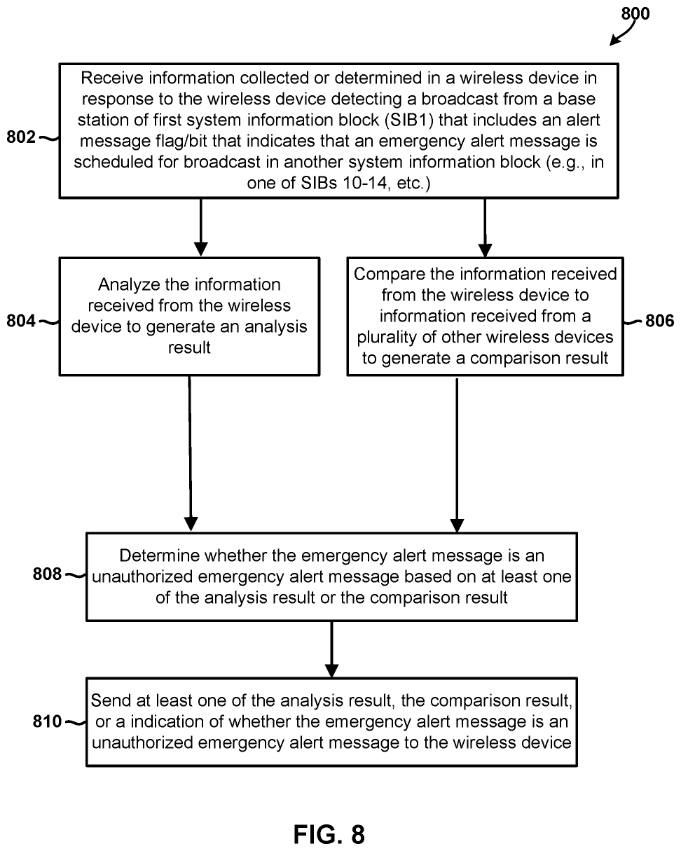

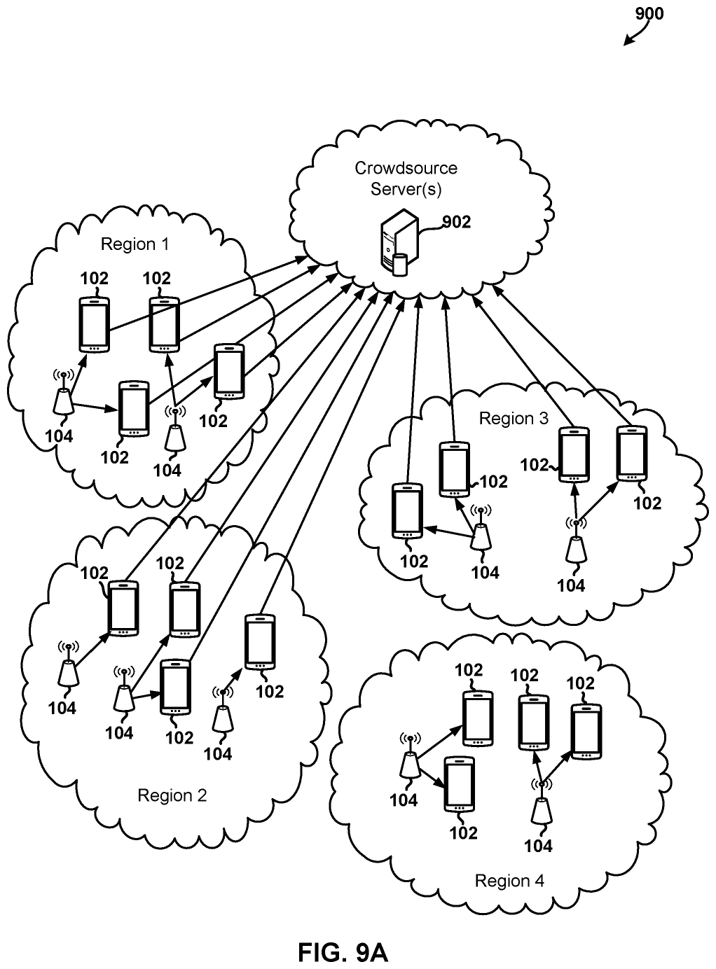

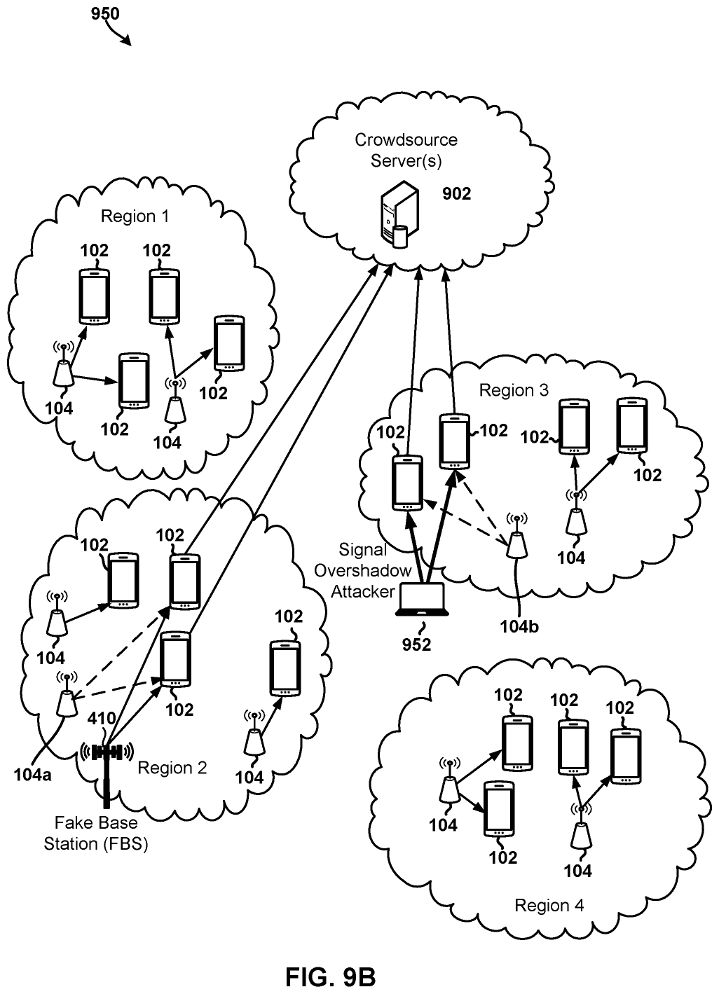

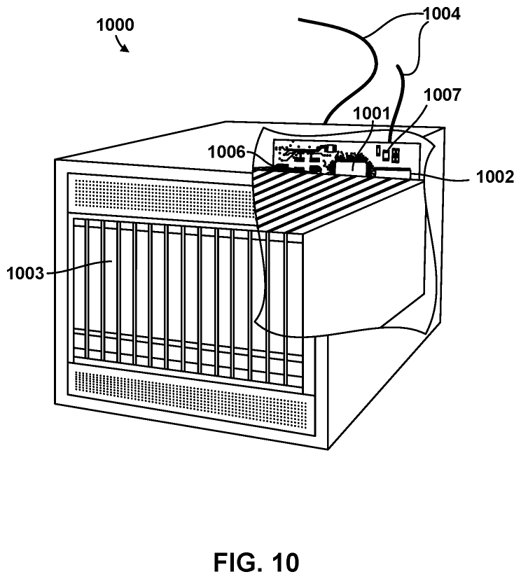

FIG. 8 illustrates a method 800 of a server detecting and responding to unauthorized presidential alerts and unauthorized emergency messages in accordance with an embodiment. The method 800 may be performed by a processor in server computing device (e.g., crowdsource server computing device 902 illustrated in FIGS. 9A and 9B, server computing device 1000 illustrated in FIG. 10, etc.).

In block 802, a processor in a server computing device (server processor) may receive information collected or determined in a wireless device. The information may have been collected or determined in wireless device in response to the wireless device detecting a broadcast from a base station. The detected broadcast may include a first system information block (SIB1) that includes an alert message flag that indicates that an emergency alert message is scheduled for broadcast in another system information block (e.g., in one of SIBs 10-14, etc.).

In block 804, the server processor may analyze the information received from the wireless device to generate an analysis result. The analysis result may include information regarding detected SIB1 messages from one or more base stations (legitimate or unauthorized) and in some instances copies of received emergency alert messages.

In block 806, the server processor may compare the information received from the wireless device to information received from a plurality of other wireless devices to generate a comparison result. The comparison result may include identifying or counting instances in which the SIB1 message emergency alert flags and/or emergency alert messages received from various wireless devices are different.

In block 808, the server processor may determine whether the emergency alert message is an unauthorized alert message based on at least one of the analysis results or the comparison result as described herein. For example, if one or more wireless devices reports that an SIB1 message includes a set emergency alert flag while other wireless devices report that received SIB1 messages do not include a set emergency alert flag, the server processor may determine that an unauthorized alert message (or indications of such a message) is being broadcast by a fake or unauthorized base station. Similarly, two or more wireless devices forward received emergency alert messages, the server processor may determine that an unauthorized alert message is being broadcast by a fake or unauthorized base station.

In block 810, the server processor may send at least one of the analysis results, the comparison result, or an indication of whether the emergency alert message is an unauthorized alert message to the wireless device. The wireless device may receive and use the information from the server to determine whether the emergency alert message received from the base station is an unauthorized alert message. The wireless device may also receive and use the information from the server to update its previous classification of the emergency alert message as a valid or an unauthorized alert message in the methods 600 or 700.

FIGS. 9A and 9B illustrate systems 900, 950 that include a crowdsource server 902 and a plurality of wireless devices 102 attached to base stations 104 that are included in various different regions (Regions 1-4). Each of Regions 1-4 may represent a city, county, state, country or other definable or well-defined area.

In the example illustrated in FIG. 9A, the crowdsource server 902 receives information (e.g., as part of the operations in block 802 of FIG. 8, etc.) indicating the presence of an emergency alert message from many of the wireless devices 102 in Region 1, Region 2 and Region 3. The crowdsource server 902 may analyze the received information and/or compare the information from different wireless devices 102. For example, the crowdsource server 902 may evaluate the content and type of emergency alert messages (e.g., a president's message, earthquake, tsunami, fire, Amber Alert, etc.) received by the wireless devices 102 to determine the intended or expected range of the messages (e.g., city-wide, county-wide, state-wide, nationwide, geometric shape as a circle or polygon such as defined in the CAPS protocol for localized alerts, etc.). As another example, the crowdsource server 902 may generate metadata based on the alert type, the message contents, the time emergency alert message was sent, the locations of the wireless devices 102 that received the emergency alert message, base station 104 information (e.g., PLMN, ID), etc. The crowdsource server 902 may compare the metadata generated based on information received from different wireless devices 102 that are in the same or similar location, geographic area, or cell as the wireless device to determine whether they are consistent or if the contents of messages are well correlated.

Based on the evaluation/comparison results, the crowdsource server 902 may determine that the message intended/expected range of the message encompasses Regions 1-3. The crowdsource server 902 may determine that the emergency alert message is not an unauthorized alert message (i.e., is a valid emergency alert message) if a large percentage of the wireless devices within intended/expected range of the message (e.g., Regions 1-3) provided the crowdsource server 902 with the same, similar or consistent information.

In the example illustrated in FIG. 9B, the crowdsource server 902 receives information indicating the presence of an emergency alert message from only a small subset of the wireless devices 102 in Region 2 and Region 3. The crowdsource server 902 may determine that the emergency alert message is an unauthorized alert message in response to determining that only a small subset of devices that are within intended or expected range of the message (e.g., city-wide, county-wide, state-wide, nationwide, geometric shape as a circle or polygon such as defined in the CAPS protocol for localized alerts, etc.) indicated to the crowdsource server 902 that they received an emergency alert message.

The crowdsource server 902 may analyze the received information and/or compare the information from different wireless devices 102, and determine that all of the wireless devices 102 in Region 2 that received the message are attached to a specific base station 104a. The crowdsource server 902 may further analyze the received information to determine that the wireless devices 102 in Region 2 that received the message have attached to a fake or unauthorized base station 410. Similarly, the crowdsource server 902 may determine that some or all of the wireless devices 102 in Region 3 that received the message are subject to a signal overshadow attacker 952.

If the server receives data indicating a specific Cell ID is showing both Alert and no Alert at the same time, the server may determine there is one or more fake or unauthorized base stations operating in the area. If the server determines there is an Alert, then the area showing no alert has the fake or unauthorized base station. If the server determines there is no Alert, then the areas receiving the Alert have fake or unauthorized base station(s) sending the False Alert. If the server receives data indicating a specific Cell ID is showing an Alert presence value (SIB12 scheduled in SIB1) in the same geographic area at the same time as other Cells in the same PLMN but with a different value, the server may determine that the transmitter associated with that Cell ID is a Fake or unauthorized base station.

The server computing device may send the metadata or results of its evaluations, analysis, comparisons, or determinations (e.g., a threat detection result, etc.) to the wireless device and/or other similarly situated wireless devices (e.g., other devices in the same area as the wireless device, etc.). The wireless device may use the information received from the server to update its classification of the received emergency alert message, to detect other emergency alert messages, and/or to take other responsive actions.

FIG. 10 shows a component block diagram of an example network computing device 1000, such as a base station, suitable for use in various implementations. Such network computing devices may include at least the components illustrated in FIG. 10. With reference to FIG. 1-9B, the network computing device 1000 may typically include a processor 1001 coupled to volatile memory 1002 and a large capacity nonvolatile memory, such as a disk drive 1003. The network computing device 1000 also may include a peripheral memory access device such as a floppy disc drive, compact disc (CD) or digital video disc (DVD) drive 1006 coupled to the processor 1001. The network computing device 1000 also may include network access ports 1004 (or interfaces) coupled to the processor 1001 for establishing data connections with a network, such as the Internet or a local area network coupled to other system computers and servers. The network computing device 1000 may include one or more antennas 1007 for sending and receiving electromagnetic radiation that may be connected to a wireless communication link. The network computing device 1000 may include additional access ports, such as USB, Firewire, Thunderbolt, and the like for coupling to peripherals, external memory, or other devices.

FIG. 11 shows a component block diagram of an example wireless device 1100 suitable for use in various implementations. In various implementations, the wireless device 1100 may be similar to the wireless devices 102, 200, and 320 shown in FIGS. 1A-4. A wireless device 1100 may include a first SOC 202 (such as a SOC-CPU) coupled to a second SOC 204 (such as a 5G capable SOC). The first and second SOCs 202, 204 may be coupled to internal memory 1106, 1116, a display 1112, and to a speaker 1114. Additionally, a wireless device 1100 may include an antenna 1104 for sending and receiving electromagnetic radiation that may be connected to a wireless data link or cellular telephone transceiver 1108 coupled to one or more processors in the first or second SOCs 202, 204. A wireless device 1100 typically also includes menu selection buttons or rocker switches 1120 for receiving user inputs.

A wireless device 1100 also includes a sound encoding/decoding (CODEC) circuit 1110, which digitizes sound received from a microphone into data packets suitable for wireless transmission and decodes received sound data packets to generate analog signals that are provided to the speaker to generate sound. Also, one or more of the processors in the first and second SOCs 202, 204, wireless transceiver 1108 and CODEC 1110 may include a digital signal processor (DSP) circuit (not shown separately).

The processors of a network computing device 1100 and a wireless device 1100 may be any programmable microprocessor, microcomputer or multiple processor chip or chips that can be configured by software instructions (applications) to perform a variety of functions, including the functions of the various implementations described below. In some wireless devices, multiple processors may be provided, such as one processor within an SOC 204 dedicated to wireless communication functions and one processor within an SOC 202 dedicated to running other applications. Typically, software applications may be stored in the memory 1106, 1116 before they are accessed and loaded into the processor. The processors may include internal memory sufficient to store the application software instructions.

Various implementations illustrated and described are provided merely as examples to illustrate various features of the claims. However, features shown and described with respect to any given implementation are not necessarily limited to the associated implementation and may be used or combined with other implementations that are shown and described. Further, the claims are not intended to be limited by any one example implementation. For example, one or more of the operations of the methods 500, 600, 700 and 800 may be substituted for or combined with one or more operations of the methods 500, 600, 700 and 800.

The foregoing method descriptions and the process flow diagrams are provided merely as illustrative examples and are not intended to require or imply that the blocks of the various embodiments must be performed in the order presented. As will be appreciated by one of skill in the art the order of blocks in the foregoing embodiments may be performed in any order. Words such as “thereafter,” “then,” “next,” etc. are not intended to limit the order of the blocks; these words are simply used to guide the reader through the description of the methods. Further, any reference to claim elements in the singular, for example, using the articles “a,” “an” or “the” is not to be construed as limiting the element to the singular.

The various illustrative logical blocks, modules, circuits, and algorithm blocks described in connection with the embodiments disclosed herein may be implemented as electronic hardware, computer software, or combinations of both. To clearly illustrate this interchangeability of hardware and software, various illustrative components, blocks, modules, circuits, and blocks have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.

The hardware used to implement the various illustrative logics, logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but, in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Alternatively, some blocks or methods may be performed by circuitry that is specific to a given function.

The functions described for various embodiments may be implemented in hardware, software, firmware, or any combination thereof. If implemented in software, the functions may be stored as one or more instructions or code on a non-transitory computer-readable storage medium or non-transitory processor-readable storage medium. The steps of a method or algorithm disclosed herein may be embodied in a processor-executable software module which may reside on a non-transitory computer-readable or processor-readable storage medium. Non-transitory computer-readable or processor-readable storage media may be any storage media that may be accessed by a computer or a processor. By way of example but not limitation, such non-transitory computer-readable or processor-readable media may include RAM, ROM, EEPROM, FLASH memory, CD-ROM or other optical disk storage, magnetic disk storage or other magnetic storage devices, or any other medium that may be used to store desired program code in the form of instructions or data structures and that may be accessed by a computer. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above are also included within the scope of non-transitory computer-readable and processor-readable media. Additionally, the operations of a method or algorithm may reside as one or any combination or set of codes and/or instructions on a non-transitory processor-readable medium and/or computer-readable medium, which may be incorporated into a computer program product.

The preceding description of the disclosed embodiments is provided to enable any person skilled in the art to make or use the claims. Various modifications to these embodiments will be readily apparent to those skilled in the art, and the generic principles defined herein may be applied to other embodiments without departing from the scope of the claims. Thus, the claims are not intended to be limited to the embodiments shown herein but are to be accorded the widest scope consistent with the following claims and the principles and novel features disclosed herein.

What is claimed is:

1. A method of detecting unauthorized alert messages, comprising:
detecting, by a processor in a wireless device, a broadcast from a base station of a first system information block (SIB1) that includes an alert message flag that indicates that an emergency alert message is scheduled for broadcast in another system information block;
receiving, by the processor, the emergency alert message from the base station in response to the SIB1 including an alert message flag that indicates that an emergency alert message is scheduled for broadcast;
activating, by the processor, receiver circuitry to scan for SIB1 broadcasts from current neighbor base stations that are within communication range of the wireless device in response to the SIB1 including an alert message flag that indicates that an emergency alert message is scheduled for broadcast;
receiving, by the processor, an SIB1 broadcast by a current neighbor base station;
determining, by the processor, whether the SIB1 broadcast by the current neighbor base station includes the alert message flag that indicates that an emergency alert message is scheduled for broadcast; and
determining, by the processor, whether the emergency alert message received from the base station is an unauthorized alert message based on whether the SIB1 broadcast by the current neighbor base station includes the alert message flag that indicates that an emergency alert message is scheduled for broadcast.

2. The method of claim 1, wherein determining whether the emergency alert message received from the base station is an unauthorized alert message comprises:
determining a valid alert count value, a valid alert probability value, and an unauthorized alert probability value;
determining whether the valid alert count value is equal to zero;
determining whether the unauthorized alert probability value exceeds the valid alert probability value; and
determining that the emergency alert message received from the base station is an unauthorized alert message in response to determining that the valid alert count value is equal to zero and that the unauthorized alert probability value exceeds the valid alert probability value.

3. The method of claim 1, further comprising:
increasing an unauthorized alert probability value in response to determining that the alert message flag in the SIB1 broadcast by the current neighbor base station does not indicate that an emergency alert message is scheduled for broadcast; or
increasing the unauthorized alert probability value in response to determining that the alert message flag in the SIB1 broadcast by the current neighbor base station does not indicate that an emergency alert message is scheduled for broadcast.

4. The method of claim 1, further comprising:
increasing a valid alert probability value and activating the receiver circuitry to receive the scheduled emergency alert message from the current neighbor base station in response to determining that the alert message flag in the SIB1 broadcast by the current neighbor base station indicates that an emergency alert message is scheduled for broadcast; and
comparing the emergency alert message received from the current neighbor base station to the emergency alert message received from the base station,
wherein determining whether the emergency alert message received from the base station is an unauthorized alert message comprises:
determining whether the emergency alert message received from the base station is an unauthorized alert message based on a result of comparing the emergency alert message received from the current neighbor base station to the emergency alert message received from the base station.

5. The method of claim 4, wherein determining whether the emergency alert message received from the base station is an unauthorized alert message based on the result of comparing the emergency alert message received from the current neighbor base station to the emergency alert message received from the base station comprises:
increasing an unauthorized alert probability value in response to determining, based on the comparison, that the emergency alert message sent from the current neighbor base station is not substantially the same as the emergency alert message received from the base station.

6. The method of claim 4, wherein determining whether the emergency alert message received from the base station is an unauthorized alert message further comprises:
increasing the valid alert probability value and incrementing a valid alert count value in response to determining, based on the comparison, that the emergency alert message sent from the current neighbor base station is substantially the same as the emergency alert message received from the base station.

7. The method of claim 1, further comprising:
collecting information from multiple base stations that communicate with the wireless device;
categorizing the base stations into groups based on the collected information;
generating a list of neighboring base stations that includes that communicate with the wireless device and the groups into which they are categorized; and
generating a list that identifies all of the current neighbor base stations that are within communication range of the wireless device and included in the list of neighboring base stations; and
prioritizing the generated list based on the groups into which the current neighbor base stations are categorized to generate a prioritized list.

8. The method of claim 7, wherein activating the receiver circuitry to scan for SIB1 broadcasts from the current neighbor base stations that are within communication range of the wireless device comprises:
traversing the prioritized list to select an unscanned base station having a highest priority;
scanning for SIB1 broadcasts from the selected base station; and
labeling the base station as scanned.

9. The method of claim 8, wherein activating the receiver circuitry to scan for SIB1 broadcasts from the current neighbor base stations that are within communication range of the wireless device further comprises:
continuing to sequentially traverse the prioritized list to select other unscanned base stations based on their priorities or positions within the prioritized list until all unscanned base stations in the prioritized list are scanned or until a predefined number of base stations are scanned; and
scanning for SIB1 broadcasts from each of the selected base stations.

10. The method of claim 1, further comprising:
sending information collected or determined in the wireless device to a server computing device; and
receiving a threat detection result from the server computing device,
wherein determining whether the emergency alert message received from the base station is an unauthorized alert message further comprises determining whether the emergency alert message received from the base station is an unauthorized alert message based on the received threat detection result.

11. The method of claim 10, wherein sending the information collected or determined in the wireless device to the server computing device comprises sending at least one or more of:
information indicating whether the emergency alert message was received in the wireless device;
information identifying a type of the emergency alert message;
a classification of the emergency alert message;
a date/time stamped version of cells used to determine if unauthorized or valid with SIB1's SIB12 scheduling value;
a valid alert value;
a unauthorized alert value;
content of the emergency alert message;
a message number associated with the emergency alert message;
a geographic region in which the emergency alert message was received;
information regarding a tracking area or cell in which the wireless device received the emergency alert message; or
information regarding the base station from which the wireless device received the emergency alert message.

12. A wireless device, comprising:
a processor configured with processor-executable instructions to:
detect a broadcast from a base station of a first system information block (SIB1) that includes an alert message flag that indicates that an emergency alert message is scheduled for broadcast in another system information block;
receive the emergency alert message from the base station in response to the SIB1 including an alert message flag that indicates that an emergency alert message is scheduled for broadcast;
activate receiver circuitry to scan for SIB1 broadcasts from current neighbor base stations that are within communication range of the wireless device in response to the SIB1 including an alert message flag that indicates that an emergency alert message is scheduled for broadcast;
receive an SIB1 broadcast by a current neighbor base station;
determine whether the SIB1 broadcast by the current neighbor base station includes the alert message flag that indicates that an emergency alert message is scheduled for broadcast; and
determine whether the emergency alert message received from the base station is an unauthorized alert message based on whether the SIB1 broadcast by the current neighbor base station includes the alert message flag that indicates that an emergency alert message is scheduled for broadcast.

13. The wireless device of claim 12, wherein the processor is configured with processor-executable instructions to determine whether the emergency alert message received from the base station is an unauthorized alert message by:
determining a valid alert count value, a valid alert probability value, and an unauthorized alert probability value;
determining whether the valid alert count value is equal to zero;
determining whether the unauthorized alert probability value exceeds the valid alert probability value; and
determining that the emergency alert message received from the base station is an unauthorized alert message in response to determining that the valid alert count value is equal to zero and that the unauthorized alert probability value exceeds the valid alert probability value.

14. The wireless device of claim 12, wherein the processor is configured with processor-executable instructions to:
increase an unauthorized alert probability value in response to determining that the alert message flag in the SIB1 broadcast by the current neighbor base station does not indicate that an emergency alert message is scheduled for broadcast; or
increase the unauthorized alert probability value in response to determining that the alert message flag in the SIB1 broadcast by the current neighbor base station does not indicate that an emergency alert message is scheduled for broadcast.

15. The wireless device of claim 12,
wherein the processor is configured with processor-executable instructions to:
increase a valid alert probability value and activating receiver circuitry to receive the scheduled emergency alert message from the current neighbor base station in response to determining that the alert message flag in the SIB1 broadcast by the current neighbor base station indicates that an emergency alert message is scheduled for broadcast; and
compare the emergency alert message received from the current neighbor base station to the emergency alert message received from the base station, and
wherein the processor is configured with processor-executable instructions to determine whether the emergency alert message received from the base station is an unauthorized alert message by determining whether the emergency alert message received from the base station is an unauthorized alert message based on a result of comparing the emergency alert message received from the current neighbor base station to the emergency alert message received from the base station.

16. The wireless device of claim 15, wherein the processor is configured with processor-executable instructions to determine whether the emergency alert message received from the base station is an unauthorized alert message based on the result of comparing the emergency alert message received from the current neighbor base station to the emergency alert message received from the base station by:
increasing an unauthorized alert probability value in response to determining, based on the comparison, that the emergency alert message sent from the current neighbor base station is not substantially the same as the emergency alert message received from the base station.

17. The wireless device of claim 15, wherein the processor is configured with processor-executable instructions to determine whether the emergency alert message received from the base station is an unauthorized alert message further by:
increasing the valid alert probability value and incrementing a valid alert count value in response to determining, based on the comparison, that the emergency alert message sent from the current neighbor base station is substantially the same as the emergency alert message received from the base station.

18. The wireless device of claim 12, wherein the processor is configured with processor-executable instructions to:
collect information from multiple base stations that communicate with the wireless device;
categorize the base stations into groups based on the collected information;
generate a list of neighboring base stations that includes that communicate with the wireless device and the groups into which they are categorized; and
generate a list that identifies all of the current neighbor base stations that are within communication range of the wireless device and included in the list of neighboring base stations; and
prioritize the generated list based on the groups into which the current neighbor base stations are categorized to generate a prioritized list.

19. The wireless device of claim 18, wherein the processor is configured with processor-executable instructions to scan for SIB1 broadcasts from the current neighbor base stations that are within communication range of the wireless device by:
traversing the prioritized list to select an unscanned base station having a highest priority;
scanning for SIB1 broadcasts from the selected base station; and
labeling the base station as scanned.

20. The wireless device of claim 12,
wherein the processor is configured with processor-executable instructions to:
send information collected or determined in the wireless device to a server computing device; and
receive a threat detection result from the server computing device; and
wherein the processor is configured with processor-executable instructions to determine whether the emergency alert message received from the base station is an unauthorized alert message by determining whether the emergency alert message received from the base station is an unauthorized alert message based on the received threat detection result.

21. A non-transitory processor-readable storage medium having stored thereon processor-executable instructions configured to cause a processor of a wireless device to perform operations for detecting and responding to unauthorized alert messages, the operations comprising:
detecting a broadcast from a base station of a first system information block (SIB1) that includes an alert message flag that indicates that an emergency alert message is scheduled for broadcast in another system information block;
receiving the emergency alert message from the base station in response to the SIB1 including an alert message flag that indicates that an emergency alert message is scheduled for broadcast;
activating receiver circuitry to scan for SIB1 broadcasts from current neighbor base stations that are within communication range of the wireless device in response to the SIB1 including an alert message flag that indicates that an emergency alert message is scheduled for broadcast;
receiving an SIB1 broadcast by a current neighbor base station;
determining whether the SIB1 broadcast by the current neighbor base station includes the alert message flag that indicates that an emergency alert message is scheduled for broadcast; and
determining whether the emergency alert message received from the base station is an unauthorized alert message based on whether the SIB1 broadcast by the current neighbor base station includes the alert message flag that indicates that an emergency alert message is scheduled for broadcast.

22. The non-transitory processor-readable storage medium of claim 21, wherein the stored processor-executable instructions are configured to cause the processor to perform operations such that determining whether the emergency alert message received from the base station is an unauthorized alert message comprises:
determining a valid alert count value, a valid alert probability value, and an unauthorized alert probability value;
determining whether the valid alert count value is equal to zero;
determining whether the unauthorized alert probability value exceeds the valid alert probability value; and
determining that the emergency alert message received from the base station is an unauthorized alert message in response to determining that the valid alert count value is equal to zero and that the unauthorized alert probability value exceeds the valid alert probability value.

23. The non-transitory processor-readable storage medium of claim 21, wherein the stored processor-executable instructions are configured to cause the processor to perform operations further comprising:
increasing an unauthorized alert probability value in response to determining that the alert message flag in the SIB1 broadcast by the current neighbor base station does not indicate that an emergency alert message is scheduled for broadcast; or
increasing the unauthorized alert probability value in response to determining that the alert message flag in the SIB1 broadcast by the current neighbor base station does not indicate that an emergency alert message is scheduled for broadcast.

24. The non-transitory processor-readable storage medium of claim 21, wherein the stored processor-executable instructions are configured to cause the processor to perform operations further comprising:
increasing a valid alert probability value and activating the receiver circuitry to receive the scheduled emergency alert message from the current neighbor base station in response to determining that the alert message flag in the SIB1 broadcast by the current neighbor base station indicates that an emergency alert message is scheduled for broadcast; and
comparing the emergency alert message received from the current neighbor base station to the emergency alert message received from the base station,
wherein determining whether the emergency alert message received from the base station is an unauthorized alert message comprises:
determining whether the emergency alert message received from the base station is an unauthorized alert message based on a result of comparing the emergency alert message received from the current neighbor base station to the emergency alert message received from the base station.

25. The non-transitory processor-readable storage medium of claim 24, wherein the stored processor-executable instructions are configured to cause the processor to perform operations such that determining whether the emergency alert message received from the base station is an unauthorized alert message based on the result of comparing the emergency alert message received from the current neighbor base station to the emergency alert message received from the base station comprises:
increasing an unauthorized alert probability value in response to determining, based on the comparison, that the emergency alert message sent from the current neighbor base station is not substantially the same as the emergency alert message received from the base station.

26. The non-transitory processor-readable storage medium of claim 24, wherein the stored processor-executable instructions are configured to cause the processor to perform operations such that determining whether the emergency alert message received from the base station is an unauthorized alert message further comprises:
increasing the valid alert probability value and incrementing a valid alert count value in response to determining, based on the comparison, that the emergency alert message sent from the current neighbor base station is substantially the same as the emergency alert message received from the base station.

27. The non-transitory processor-readable storage medium of claim 26, wherein the stored processor-executable instructions are configured to cause the processor to perform operations further comprising:
collecting information from multiple base stations that communicate with the wireless device;
categorizing the base stations into groups based on the collected information;
generating a list of neighboring base stations that includes that communicate with the wireless device and the groups into which they are categorized; and
generating a list that identifies all of the current neighbor base stations that are within communication range of the wireless device and included in the list of neighboring base stations; and
prioritizing the generated list based on the groups into which the current neighbor base stations are categorized to generate a prioritized list.

28. The non-transitory processor-readable storage medium of claim 27, wherein the stored processor-executable instructions are configured to cause the processor to perform operations such that activating the receiver circuitry to scan for SIB1 broadcasts from the current neighbor base stations that are within communication range of the wireless device comprises:
traversing the prioritized list to select an unscanned base station having a highest priority;
scanning for SIB1 broadcasts from the selected base station; and
labeling the base station as scanned.

29. The non-transitory processor-readable storage medium of claim 21, wherein the stored processor-executable instructions are configured to cause the processor to perform operations further comprising:
sending information collected or determined in the wireless device to a server computing device; and
receiving a threat detection result from the server computing device,
wherein determining whether the emergency alert message received from the base station is an unauthorized alert message further comprises determining whether the emergency alert message received from the base station is an unauthorized alert message based on the received threat detection result.

30. A wireless device, comprising:
means for detecting a broadcast from a base station of a first system information block (SIB1) that includes an alert message flag that indicates that an emergency alert message is scheduled for broadcast in another system information block;
means for receiving the emergency alert message from the base station in response to the SIB1 including an alert message flag that indicates that an emergency alert message is scheduled for broadcast;
means for activating receiver circuitry to scan for SIB1 broadcasts from current neighbor base stations that are within communication range of the wireless device in response to the SIB1 including an alert message flag that indicates that an emergency alert message is scheduled for broadcast;
means for receiving an SIB1 broadcast by a current neighbor base station;
means for determining whether the SIB1 broadcast by the current neighbor base station includes the alert message flag that indicates that an emergency alert message is scheduled for broadcast; and
means for determining whether the emergency alert message received from the base station is an unauthorized alert message based on whether the SIB1 broadcast by the current neighbor base station includes the alert message flag that indicates that an emergency alert message is scheduled for broadcast.
